(19) United States
(12) Patent Application Publication
(10) Pub. No.: US 2009/0239629 A1
(43) Pub. Date: Sep. 24, 2009

(54) Gaming Machine Which Awards Payout of Rank According to Execution Result of Special Game and Playing Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/254,392

(22) Filed: Oct. 20, 2008

Related U.S. Application Data
(60) Provisional application No. 61/038,558, filed on Mar. 21, 2008.

(51) Int. Cl. A63F 9/24; A63F 13/00

(52) U.S. Cl. 463/20; 463/25

(57) ABSTRACT

In the gaming machine 1, concurrently run are a base game offering a chance of winning a payout according to a predetermined combination and a chance game offering a chance of obtaining a JP chance which qualifies a player to join a JP game offering a chance of winning a higher payout than the base game. A payout is determined according to a result of the base game and awarded. In accordance with a result of the chance game, there is determined whether a JP chance is awarded. When a JP chance is awarded, the number of awarded JP chances is stored in the RAM 243 in association with the time of awarding the JP chance specified by the IC 280. A timing to run a JP game is determined in accordance with the timing to award the JP chance. A pointer image 167 based on the timing to run the JP game is displayed on the shared display 203. At the timing to run the JP game, the JP game is run in which a player participates by consuming a JP chance stored in the RAM 243. A rank is determined according to a result of the JP game and awarded. A payout of the JP game is determined according to the determined rank and the timing to run the JP game. The determined payout of the JP game is awarded.

### CROSS REFERENCE TO RELATED APPLICATION

The present application claims priority from Provisional Patent Application No. 61/038,558, which was filed on Mar. 21, 2008, the disclosure of which is herein incorporated by reference in its entirety.

### BACKGROUND OF THE INVENTION

1. Field of the Invention

The present invention relates to a gaming machine and a playing method thereof.

2. Description of Related Art

A known gaming machine includes gaming terminals, terminal controllers which are provided in the respective gaming terminals and each of which causes the associated gaming terminal to run a game, and a center controller which controls the terminal controllers. Such a known gaming machine is, for example, disclosed in the specifications of U.S. Pat. No. 5,820,459, U.S. Pat. No. 4,283,709, and U.S. Pat. No. 6,003,013. Each terminal controller independently runs a game for each gaming terminal and is configured to award a payout according to a result of the game. The center controller provides various types of jackpot such as progressive jackpot and mystery jackpot.

An object of the present invention is to provide a gaming machine having an entertainment characteristic unexpected from the aforesaid known machine, and a playing method of the gaming machine.

It is another object of the present invention to provide a gaming machine and a playing method thereof, each realizing a new gaming characteristic by qualifying a player to join a special game through a chance game run at the same time a base game is run.

### SUMMARY OF THE INVENTION

A gaming machine of the present invention comprises: a base game offering a chance of winning a payout according to a predetermined combination; a special game offering a chance of winning a higher payout than the base game; a chance game offering a chance of obtaining a chance flag which qualifies a player to join the bonus game; a timer which specifies a timing at which the chance flag is awarded; a chance flag memory which stores the number of awarded chance flags, a display which displays an image based on the chance flag and the timing; and a controller which is programmed to perform the steps of: (a1) running the base game and the chance game at the same time; (a2) determining and awarding a payout according to a result of the base game; (a3) determining whether to award a chance flag according to a result of the chance game; (a4) if the chance flag is awarded, storing the number of awarded chance flags in the chance flag memory, in association with a timing at which the chance flag is awarded, which is specified by the timer; (a5) determining a timing to run the special game based on the timing at which the chance flag is awarded; (a6) displaying on the display an image based on the timing to run the special game; (a7) at the timing to run the special game, running the special game in which the player participates by consuming the chance flag stored in the chance flag memory; (a8) determining a rank according to a result of the special game; (a9) determining a payout of the special game according to the determined rank and the timing to run the special game; and (a10) awarding the determined payout of the special game.

In this arrangement, concurrently run are a base game offering a chance of winning a payout according to a predetermined combination and a chance game offering a chance of obtaining a chance flag which qualifies a player to join a special game offering a chance of winning a higher payout than the base game. A payout is determined according to a result of the base game and is awarded. In accordance with a result of the chance game, there is determined whether or not a chance flag is awarded. When a chance flag is awarded, the number of awarded chance flags is stored in the chance flag memory, in association with a timing of awarding the chance flag specified by the timer. Based on a timing at which the chance flag is awarded, a timing to run a special game is determined. An image based on the timing to run the special game is displayed on the display. At the timing to run the special game, the special game is run in which a player participates by consuming the chance flag stored in the chance flag memory. A rank is determined according to a result of the special game. A payout of the special game is determined according to the determined rank and the timing to run the special game. The determined payout of the special game is awarded.

In this way, a payout of a special game is determined by a rank determined according to a result of the special game and the timing to run the special game. This provides a player with a new entertainment characteristic.

Furthermore, since a timing to run a special game is displayed on the display, a player is motivated to continue a game thanks to decreased stress on him/her.

A gaming machine of the present invention comprises: gaming terminals each capable of independently running a game; a base game offering a chance of winning a payout according to a predetermined combination; a special game offering a chance of winning a higher payout than the base game, in which game the gaming terminals participate in turn; a chance game offering a chance of obtaining a chance flag which qualifies a player to join the bonus game; a timer which specifies a timing at which the chance flag is awarded; a chance flag memory which stores the number of awarded chance flags, a display which displays an image based on the chance flag and the timing; and a result memory which stores a rank according to a result of the special game and a payout in association with one another; and a controller which is programmed to perform the steps of: (b1) running the base game and the chance game at the same time in each of the gaming terminals; (b2) determining and awarding a payout according to a result of the base game; (b3) determining whether to award a chance flag according to a result of the chance game; (b4) if the chance flag is awarded, storing the number of awarded chance flags in the chance flag memory for each of the gaming terminals, in association with a timing at which the chance flag is awarded, which is specified by the timer; (b5) determining a timing to run the special game based on the timing at which the chance flag is awarded; (b6) displaying on the display an image based on the timing to run the special game; (b7) at the timing to run the special game, running the special game in which the player participates by consuming the chance flag stored in the chance flag memory; (b8) determining a rank according to a result of the special game; (b9) if the result memory stores a result whose rank is identical with the determined rank, determining a payout of the special game to be lower than a payout of the result stored in the result memory; and (b10) storing the determined payout of the special game in the result memory in association with the determined rank and awarding the determined payout of the special game.

In this arrangement, concurrently run in each of the gaming terminals capable of independently running a game are a base game offering a chance of winning a payout according to a predetermined combination and a chance game offering a chance of obtaining a chance flag which qualifies a player to join a special game offering a chance of winning a higher payout than the base game. A payout is determined according to a result of the base game and is awarded. In accordance with a result of the chance game, there is determined whether or not a chance flag is awarded. When a chance flag is awarded, the number of awarded chance flags is stored in the chance flag memory for each gaming terminal, in association with a timing of awarding the chance flag specified by the timer. Based on a timing at which the chance flag is awarded, a timing to run a special game is determined. An image based on the timing to run the special game is displayed on the display. At the timing to run the special game, the special game is run in which a player participates by consuming the chance flag stored in the chance flag memory. A rank is determined according to a result of the special game. If the result memory stores a result whose rank is identical with the determined rank, a payout of the special game is determined to be lower than a payout of the result stored in the result memory. The determined payout of the special game is stored in the result memory in association with the determined rank, and the determined payout of the special game is awarded.

In this way, a payout of a special game is determined by a rank determined according to a result of the special game and the timing to run the special game. This provides a player with a new entertainment characteristic. Specifically, a player for whom a special game is run earlier than for another player receives a higher payout, even if the rank of these players is the same. This provides players with a new entertainment characteristic.

Furthermore, since a timing to run a special game is displayed on the display, a player is motivated to continue a game thanks to decreased stress on him/her.

A gaming machine of the present invention comprises: a base game which is run in response to consumption of a predetermined game value and offers a chance of winning a payout according to a predetermined combination; a payout memory which accumulatively stores, as a payout for a special game, a part of the consumed game value; a special game offering a chance of winning a higher payout than the base game; a chance game offering a chance of obtaining a chance flag which qualifies a player to join the bonus game; a timer which specifies a timing at which the chance flag is awarded; a chance flag memory which stores the number of awarded chance flags, a display which displays an image based on the chance flag and the timing; and a controller which is programmed to perform the steps of: (c1) running the base game and the chance game at the same time; (c2) storing in the payout memory a part of the consumed game value; (c3) determining and awarding a payout according to a result of the base game; (c4) determining whether to award a chance flag according to a result of the chance game; (c5) if the chance flag is awarded, storing the number of awarded chance flags in the chance flag memory, in association with a timing at which the chance flag is awarded, which is specified by the timer; (c6) determining a timing to run the special game based on the timing at which the chance flag is awarded; (c7) displaying on the display an image based on the timing to run the special game; (c8) at the timing to run the special game, running the special game in which the player participates by consuming the chance flag stored in the chance flag memory; (c9) determining a rank according to a result of the special game; (c10) determining a payout of the special game according to the determined rank, the timing to run the special game, and the game value accumulatively stored in the payout memory; and (c11) awarding the determined payout of the special game.

In this arrangement, concurrently run are a base game offering a chance of winning a payout according to a predetermined combination and a chance game offering a chance of obtaining a chance flag which qualifies a player to join a special game offering a chance of winning a higher payout than the base game. A part of the consumed game value is stored in the payout memory. A payout is determined according to a result of the base game and is awarded. In accordance with a result of the chance game, there is determined whether or not a chance flag is awarded. When a chance flag is awarded, the number of awarded chance flags is stored in the chance flag memory, in association with a timing of awarding the chance flag specified by the timer. Based on a timing at which the chance flag is awarded, a timing to run a special game is determined. An image based on the timing to run the special game is displayed on the display. At the timing to run the special game, the special game is run in which a player participates by consuming the chance flag stored in the chance flag memory. A rank is determined according to a result of the special game. A payout awarded as a result of a special game is determined by (i) a rank determined according to a result of the special game, (ii) a timing to run the special game, and (iii) a game value accumulatively stored in the payout memory. The determined payout of the special game is awarded.

In this way, a payout of a special game is determined by a rank determined according to a result of the special game, the timing to run the special game, and a game value accumulatively stored in the payout memory. This provides a player with a new entertainment characteristic.

Furthermore, since a timing to run a special game is displayed on the display, a player is motivated to continue a game thanks to decreased stress on him/her.

A gaming machine of the present invention comprises: gaming terminals each capable of independently running a game; a base game which is run in response to consumption of a predetermined game value and offers a chance of winning a payout according to a predetermined combination; a payout memory which accumulatively stores, as a payout for a special game, a part of the consumed game value; a special game offering a chance of winning a higher payout than the base game, in which game the gaming terminals participate in turn; a chance game offering a chance of obtaining a chance flag which qualifies a player to join the bonus game; a timer which specifies a timing at which the chance flag is awarded; and a chance flag memory which stores the number of awarded chance flags, a display which displays an image based on the chance flag and the timing; a result memory which stores a rank according to a result of the special game and a payout in association with one another; and a controller which is programmed to perform the steps of: (d1) running the base game and the chance game at the same time in each of the gaming terminals; (d2) storing a part of the consumed game value in the payout memory; (d2) storing in the payout memory a part of the consumed game value; (d3) determining and awarding a payout according to a result of the base game; (d5) if the chance flag is awarded, storing the number of awarded chance flags in the chance flag memory for each of the gaming terminals, in association with a timing at which the chance flag is awarded, which is specified by the timer; (d6) determining a timing to run the special game based on the timing at which the chance flag is awarded; (d7) displaying on the display an image based on the timing to run the special game; (d8) at the timing to run the special game, running the special game in which the player participates by consuming the chance flag stored in the chance flag memory; (d9) determining a rank according to a result of the special game; (d10) if the result memory stores a result whose rank is identical with the determined rank, determining a payout of the special game to be lower than a payout of the result stored in the result memory, according to the game value accumulatively stored in the payout memory; and (d11) storing the determined payout of the special game in the result memory in association with the determined rank and awarding the determined payout of the special game.

In this arrangement, concurrently run in each of the gaming terminals capable of independently running a game are a base game which is run in response to consumption of a predetermined game value and offers a chance of winning a payout according to a predetermined combination and a chance game offering a chance of obtaining a chance flag which qualifies a player to join a special game offering a chance of winning a higher payout than the base game. A part of the consumed game value is stored in the payout memory. A payout is determined according to a result of the base game and is awarded. In accordance with a result of the chance game, there is determined whether or not a chance flag is awarded. When a chance flag is awarded, the number of awarded chance flags is stored in the chance flag memory for each gaming terminal, in association with a timing of awarding the chance flag specified by the timer. Based on a timing at which the chance flag is awarded, a timing to run a special game is determined. An image based on the timing to run the special game is displayed on the display. At the timing to run the special game, the special game is run in which a player participates by consuming the chance flag stored in the chance flag memory. A rank is determined according to a result of the special game. If the result memory stores a result whose rank is identical with the determined rank, a payout of the special game is determined to be lower than a payout of the result stored in the result memory, according to the game value accumulatively stored in the payout memory. The determined payout of the special game is stored in the result memory in association with the determined rank and the determined payout of the special game is awarded.

In this way, a payout of a special game is determined by a rank determined according to a result of the special game, the timing to run the special game, and a game value accumulatively stored in the payout memory. Specifically, a player for whom a special game is run earlier than for another player receives a higher payout, even if the rank of these players is the same. This provides players with a new entertainment characteristic.

Furthermore, since a timing to run a special game is displayed on the display, a player is motivated to continue a game thanks to decreased stress on him/her.

A method of playing a gaming machine of the present invention, which machine comprises: a base game offering a chance of winning a payout according to a predetermined combination; a special game offering a chance of winning a higher payout than the base game; a chance game offering a chance of obtaining a chance flag which qualifies a player to join the bonus game; a timer which specifies a timing at which the chance flag is awarded; a chance flag memory which stores the number of awarded chance flags; and a display which displays an image based on the chance flag and the timing, comprises the steps of: (e1) running the base game and the chance game at the same time; (e2) determining and awarding a payout according to a result of the base game; (e3) determining whether to award a chance flag according to a result of the chance game; (e4) if the chance flag is awarded, storing the number of awarded chance flags in the chance flag memory, in association with a timing at which the chance flag is awarded, which is specified by the timer; (e5) based on the timing at which the chance flag is awarded, determining a timing to run the special game; (e6) displaying on the display an image based on the timing to run the special game; (e7) at the timing to run the special game, running the special game in which a player participates by consuming the chance flag stored in the chance flag memory; (e8) determining a rank according to a result of the special game; (e9) determining a payout of the special game according to the determined rank and the timing to run the special game; and (e10) awarding the determined payout of the special game.

In this arrangement, concurrently run are a base game offering a chance of winning a payout according to a predetermined combination and a chance game offering a chance of obtaining a chance flag which qualifies a player to join a special game offering a chance of winning a higher payout than the base game. A payout is determined according to a result of the base game and is awarded. In accordance with a result of the chance game, there is determined whether or not a chance flag is awarded. When a chance flag is awarded, the number of awarded chance flags is stored in the chance flag memory, in association with a timing of awarding the chance flag specified by the timer. Based on a timing at which the chance flag is awarded, a timing to run a special game is determined. An image based on the timing to run the special game is displayed on the display. At the timing to run the special game, the special game is run in which a player participates by consuming the chance flag stored in the chance flag memory. A rank is determined according to a result of the special game. A payout of the special game is determined according to the determined rank and the timing to run the special game. The determined payout of the special game is awarded.

Furthermore, since a timing to run a special game is displayed on the display, a player is motivated to continue a game thanks to decreased stress on him/her.

Furthermore, since a timing to run a special game is displayed on the display, a player is motivated to continue a game thanks to decreased stress on him/her.

### BRIEF DESCRIPTION OF THE DRAWINGS

FIG. 1 illustrates a gaming machine and a playing method thereof, according to the present invention.

FIG. 2 is a block diagram of the gaming machine.

FIG. 3 is an explanatory diagram showing a display state of a lower image display panel.

FIG. 4 is an explanatory diagram of a gaming terminal showing a display state of the lower image display panel.

FIG. 5 is an explanatory diagram showing a display state of the lower image display panel.

FIG. 6 is an explanatory diagram showing display states of a shared display.

FIG. 7 illustrates symbols and code numbers of the respective symbols.

FIG. 8 is a perspective view illustrating an external appearance of the gaming machine.

FIG. 9 is a perspective view illustrating an external appearance of a gaming terminal.

FIG. 10 is a block diagram illustrating an electrical structure of the gaming terminal.

FIG. 11 is a block diagram showing an electrical structure of a center control unit.

FIG. 12 shows a JP chance data table.

FIG. 13 shows a JP result data table.

FIG. 14 is a flowchart illustrating a boot process of the gaming machine.

FIG. 15 is a flowchart illustrating an initial process of the gaming machine.

FIG. 16 is a flowchart illustrating a game running process executed by the gaming machine.

FIG. 17 is a flowchart illustrating a progressive add process executed by the gaming machine.

FIG. 18 is a flowchart illustrating a JP chance add process executed by the gaming machine.

FIG. 19 is a flowchart illustrating a JP game running process executed by the gaming machine.

FIG. 20 is a flowchart illustrating a JP game payout determining process executed by the gaming machine.

### DESCRIPTION OF THE PREFERRED EMBODIMENTS

The following describes an embodiment of a gaming machine and a playing method thereof according to the present invention.

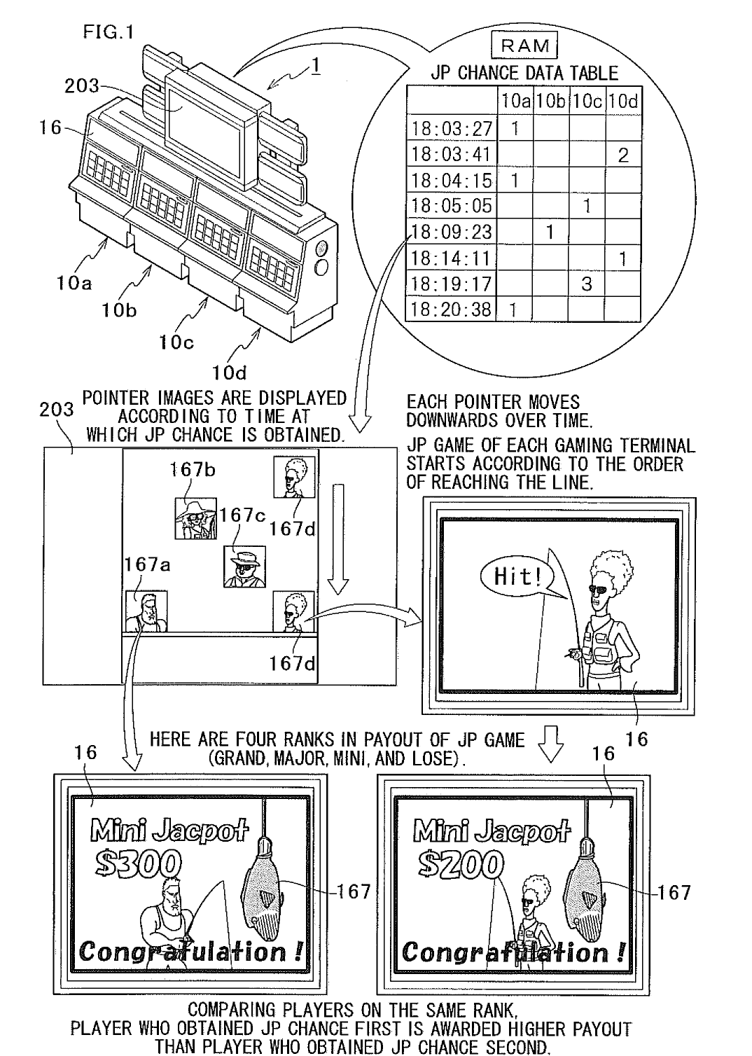

As illustrated in FIG. 1, the gaming machine is structured so that a payout as a result of a JP game which is a special game is determinable by a rank which is determined according to a result of the special game and a timing to run the special game.

More specifically, the gaming machine includes: a base game configured to award a payout according to a predetermined combination; a JP game configured to award a higher payout than the base game; a chance game configured to provide a JP chance qualifying a player to join the JP game; a timer which specifies a timing at which a JP chance is awarded; a JP chance memory which stores the number of awarded JP chances in association with the timings; a display which displays an image based on a JP chance and a timing; and a controller programmed to operate as described in the following (a1) through (a10).

A step (a1) is configured to concurrently run a base game and a chance game. A step (a2) is configured to determine and award a payout according to a result of the base game. A step (a3) is configured to determine whether to award a JP chance based on a result of the chance game. A step (a4) is configured to store, when a JP chance is awarded, the number of awarded JP chances in the JP chance memory, in association with a timing of awarding the JP chance specified by the timer. A step (a5) is configured to determine a timing to run a JP game, based on the timing of awarding the JP chance. A step (a6) is configured to display on the display an image based on the timing to run the JP game. A step (a7) is configured to execute, at the timing to run the JP game, the JP game which requires a player to consume a JP chance stored in the JP chance memory to participate in the game. A step (a8) is configured to determine a rank according to a result of the JP game. A step (a9) is configured to determine a payout of the JP game according to the determined rank and the timing to run the JP game. A step (a10) is configured to award the determined payout of the JP game.

That is to say, the gaming machine executes a playing method including the steps of: running a base game and a chance game at the same time; determining and awarding a payout according to a result of the base game; determining whether to award a JP chance, based on a result of the chance game; if a JP chance is awarded, storing in the JP chance memory the number of awarded JP chances, in association with a timing at which the JP chance is awarded, specified by the timer; determining a timing to run a JP game according to the timing to award the JP chance; displaying on the display an image according to the timing to run the JP game; running, at the timing to run the JP game, a JP game in which a player participates by consuming a JP chance stored in the JP chance memory; determining a rank according to a result of the JP game; determining a payout of the JP game according to the determined rank and the timing to run the JP game; and awarding the thus determined payout of the JP game.

In this way, a payout of a JP game is determined by a rank determined according to a result of the JP game and the timing to run the JP game. This provides a player with a new entertainment characteristic.

Furthermore, since a timing to run a JP game is displayed on the display, a player is motivated to continue a game thanks to decreased stress on him/her.

A gaming machine 1 of the present embodiment includes gaming terminals 10. A player is able to play a base game and a chance game at each gaming terminal 10. A player is also allowed to participate in a JP game which is concurrently run at all of the gaming terminals 10. The gaming machine may be a multiplayer type as in this embodiment or a single-player type. Also, the gaming machine may be structured such that gaming machines such as slot machines, each of which presupposes an independent player, are connected to be able to exchange data, so as to form a multiplayer gaming machine as a whole.

Examples of the display of the present invention include a liquid crystal display device, a CRT (cathode-ray tube) device, a plasma display device, and an organic EL (Organic Electro-Luminescence) display device. As for the display, each gaming machine may have a single display or plural displays. In case of multiplayer type, each slot machine may be provided with a display, or a large display shared by all gaming machines may be provided independently of the gaming machines. Specifically, the gaming machine 1 of the present embodiment includes a single shared display 203 and terminal displays 101 of the respective gaming terminals 10. The shared display is disposed to be viewable from each gaming terminal 10.

“Base game” is a main game of each gaming machine, and a player primarily plays this game. A player bets a predetermined game value to play the base game, and the player is awarded a payout when obtaining a predetermined result from the base game. In this embodiment, a base game is a so-called slot game arranged so that symbols are variably displayed and a payout is awarded according to a stop result of varying display

Specifically, “base game” of this embodiment is arranged such that several base symbols 180 are rearranged on respective base symbol arrangement areas 150a which are matrix-configured, and a state advantageous for a player is achieved when at least a predetermined number of base symbols 180 are displayed on the matrix. For example, the advantageous states include: a state where a payout is awarded, a state where the number of payout is added to a credit, and a state where a bonus game starts.

“Chance game” is a game to obtain a JP chance with which a player is able to qualify a JP game. In this embodiment, “chance game” is the same type of slot game as base game, and is playable at the same time as base game.

Specifically, “chance game” of this embodiment is a game in which JP symbols 180J are rearranged in JP symbol arrangement areas 150b which are matrix-configured, at the same time the base symbols 180 are rearranged in the base game. When the JP symbols 180J rearranged in the matrix-configured JP symbol arrangement areas 150b meet a winning condition, a JP chance is awarded.

Not limited to the slot game, the base game and the chance game may be roulette, horse racing, boat racing, or bicycle racing.

“JP game” is a special game which is run by a later-detailed controller 100 at the same time in two or more gaming terminals 10 at a predetermined time interval. When this JP game results in a jackpot, a higher payout than a payout awarded from the base game is awarded. The JP game is run at a predetermined timing such as every 30 minutes or the like, and is run only for gaming terminals 10 having obtained at least a predetermined number (e.g. one) of JP chances. In this embodiment, the JP game is a virtual “Fishing Tournament” played by players who have obtained JP chances. The players playing the JP game are able to see their selected characters fishing on the shared display 203.

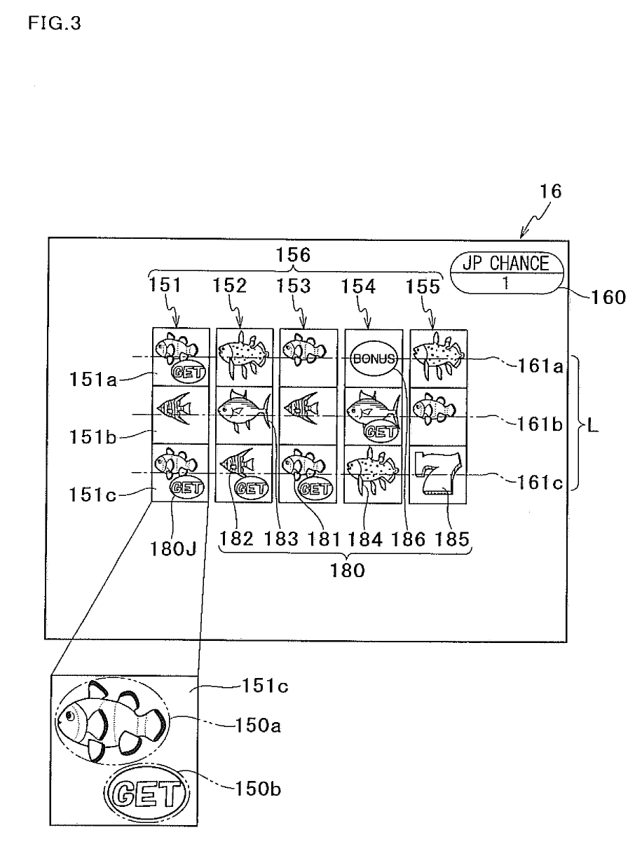

The “arrangement” in this embodiment means a state where the base symbols 180 and JP symbols 180J can be visually observed by a player. That is, as shown in FIG. 3, “arrangement” means that the base symbols 180 are displayed in the base symbol arrangement areas 150a, and the JP symbol 180J are displayed in the JP symbol arrangement areas 150b. Arranging the base symbols 180 and the JP symbols 180J again after dismissing them is referred to as “rearranging”.

Base symbols 180 are symbols used in a base game in each gaming terminal 10. For each base symbol various types of winning combinations are determined in advance. A winning combination is a combination of base symbols 180 stopping at a payline A, with which a state advantageous for a player is achieved. For example, the advantageous states include: a state where coins corresponding to scatter symbols are paid out, a state where the number of coins to be paid out is added to a credit, and a state where a bonus game is started. The payline L will be discussed later.

Further, the “JP symbols 180J” are scatter symbols, which are used in a chance game in each of the gaming terminals 10.

Each of the “scatter symbols” is a symbol whose arrangement results in a winning irrespective of any other conditions. In the present embodiment, a player is awarded a JP chance if at least a predetermined number (e.g. 3) of JP symbols 180J which are scatter symbols are arranged on the matrix 156.

The “JP chance” qualifies a player to join the JP game. For each JP chance, a process of determining whether or not a jackpot is awarded is performed once.

“Jackpot” is awarded in the following way. A part of a game value bet by a player in each base game is subtracted and the subtracted parts are accumulated as a progressive value. When a player wins a JP game, he/she is awarded a part of or all of the accumulated progressive value.

As illustrated in FIG. 1, the gaming machine may be structured so that, comparing two players in the same rank, a player for whom the JP game is run earlier than for the other player obtains a higher payout than the other player.

More specifically, the gaming machine includes: gaming terminals each capable of independently running a game; a base game configured to award a payout according to a predetermined combination; a JP game configured to award a higher payout than the base game, in which game the gaming terminals participates in turn; a chance game configured to provide a JP chance qualifying a player to join the JP game; a timer which specifies a timing to award a JP chance; a JP chance memory which stores the number of awarded JP chances, in association with the timing to award the JP chance; a display which displays an image according to the JP chance and the timing; a result memory which stores a rank according to a result of a JP game and a payout in association with one another; and a controller programmed to operate as described in the following (b1) through (b10).

A step (b1) is configured to concurrently run a base game and a chance game in each gaming terminal. A step (b2) is configured to determine and award a payout according to a result of the base game. A step (b3) is configured to determine whether to award a JP chance according to a result of a chance game. A step (b4) is configured to store, when a JP chance is awarded, the number of awarded JP chances in the JP chance memory for each gaming terminal, in association with a timing of awarding the JP chance specified by the timer. A step (b5) is configured to determine a timing to run a JP game, based on the timing of awarding the JP chance. A step (b6) is configured to display on the display an image based on the timing to run the JP game. A step (b7) is configured to execute, at the timing to run the JP game, the JP game which requires a player to consume a JP chance stored in the JP chance memory to participate in the game. A step (b8) is configured to determine a rank according to a result of the JP game. A step (b9) is configured to determine, when the result memory stores a result in the same rank as the determined rank, a payout of the JP game to be lower than the payout in the result memory. A step (b10) is configured to store in the result memory the determined payout of the JP game in association with the determined rank, and award the determined payout of the JP game.

As a result of the above, a payout of a JP game is determined by a rank determined according to a result of the JP game and a timing to run the JP game. Specifically, comparing two players in the same rank, a player for whom the JP game is run earlier than for the other player obtains a higher payout than the other player. This provides players with a new entertainment characteristic.

Furthermore, since a timing to run a JP game is displayed on the display, a player is motivated to continue a game thanks to decreased stress on him/her.

As illustrated in FIG. 1, the gaming machine may be structured so that a payout awarded as a result of a JP game is determined according to (i) a rank determined by the result of the JP game, (ii) a timing to run the JP game, and (iii) a game value accumulatively stored in the payout memory.

More specifically, the gaming machine includes: a base game which is executed in response to the consumption of a predetermined game value and is configured to award a payout according to a predetermined combination; a payout memory which accumulatively stores a part of the consumed game value as a JP game payout; a JP game configured to award a higher payout than the base game; a chance game configured to provide a JP chance qualifying a player to join the JP game; a timer which specifies a timing to award a JP chance; a JP chance memory which stores the number of awarded JP chances, in association with the timing to award the JP chance; a display which displays an image according to the JP chance and the timing; and a controller programmed to operate as described in the following (c1) through (c11).

A step (c1) is configured to concurrently run a base game and a chance game. A step (c2) is configured to store a part of the consumed game value in the payout memory. A step (c3) is configured to determine and award a payout according to a result of the base game. A step (c4) is configured to determine whether to award a JP chance, according to a result of the chance game. A step (c5) is configured to store, when a JP chance is awarded, the number of awarded JP chances in the JP chance memory, in association with a timing of awarding the JP chance specified by the timer. A step (c6) is configured to determine a timing to run a JP game, based on the timing of awarding the JP chance. A step (c7) is configured to display on the display an image based on the timing to run the JP game. A step (c8) is configured to execute, at the timing to run the JP game, the JP game which requires a player to consume a JP chance stored in the JP chance memory to participate in the game. A step (c9) is configured to determine a rank according to a result of the JP game. A step (c10) is configured to determine a payout of the JP game according to (i) the determined rank, (ii) the timing to run the JP game, and (iii) the game value accumulatively stored in the payout memory. A step (c11) is configured to award the determined payout of the JP game.

In this way, a payout of a JP game is determined by a rank determined according to a result of the JP game, the timing to run the JP game, and a game value accumulatively stored in the payout memory. This provides a player with a new entertainment characteristic.

Furthermore, since a timing to run a JP game is displayed on the display, a player is motivated to continue a game thanks to decreased stress on him/her.

As illustrated in FIG. 1, the gaming machine may be structured as follows: a payout of a JP game is determined according to (i) the determined rank, (ii) the timing to run the JP game, and (iii) the game value accumulatively stored in the payout memory, with the result that, comparing two players in the same rank, a player for whom a JP game is run earlier obtains a higher payout than the other player.

More specifically, the gaming machine includes: gaming terminals each capable of independently running a game; a base game which is executed in response to the consumption of a predetermined game value and is configured to award a payout according to a predetermined combination; a payout memory which accumulatively stores a part of the consumed game value as a JP game payout; a JP game configured to award a higher payout than the base game, in which game the gaming terminals participates in turn; a chance game configured to provide a JP chance qualifying a player to join the JP game; a timer which specifies a timing to award a JP chance; a JP chance memory which stores the number of awarded JP chances, in association with the timing to award the JP chance; a display which displays an image according to the JP chance and the timing; a result memory which stores a rank according to a result of a JP game and a payout in association with one another; and a controller programmed to operate as described in the following (d1) through (d11).

A step (d1) is configured to concurrently run a base game and a chance game in each gaming terminal. A step (d2) is configured to store in the payout memory a part of the consumed game value. A step (d3) is configured to determine and award a payout according to a result of the base game. A step (d4) is configured to determine whether to award a JP chance, according to a result of the chance game. A step (d5) is configured to store, when a JP chance is awarded, the number of awarded JP chances in the JP chance memory for each gaming terminal, in association with a timing of awarding the JP chance specified by the timer. A step (d6) is configured to determine a timing to run a JP game, based on the timing of awarding the JP chance. A step (d7) is configured to display on the display an image based on the timing to run the JP game. A step (d8) is configured to execute, at the timing to run the JP game, the JP game which requires a player to consume a JP chance stored in the JP chance memory to participate in the game. A step (d9) is configured to determine a rank according to a result of the JP game. A step (d10) is configured to determine, when a result in the same rank as the thus determined rank is stored in the result memory, a payout of the JP game to be lower than the payout of the result in the result memory, in accordance with the game value accumulatively stored in the payout memory. A step (d11) is configured to store, in the result memory, the determined payout of the JP game in association with the determined rank, and award the determined payout of the JP game.

In this way, a payout of a JP game is determined by (i) a rank determined according to a result of the JP game, (ii) the timing to run the JP game, and a game value accumulatively stored in the payout memory. Specifically, comparing two players in the same rank, a player for whom the JP game is run earlier than for the other player obtains a higher payout than the other player. This provides players with a new entertainment characteristic.

Furthermore, since a timing to run a JP game is displayed on the display, a player is motivated to continue a game thanks to decreased stress on him/her.

(Function Blocks of Gaming Machine)

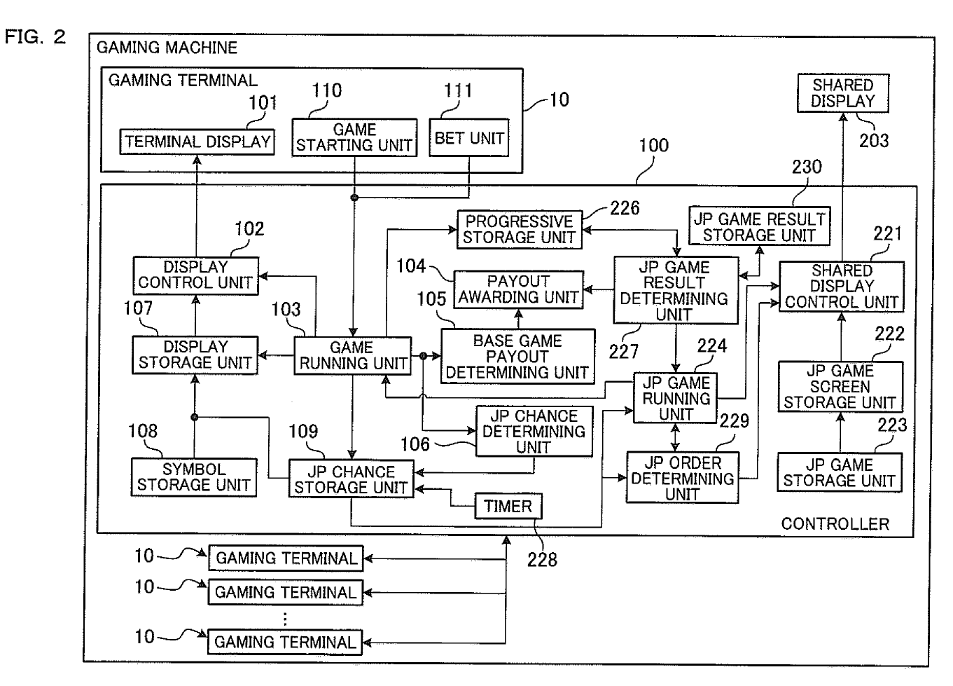

As illustrated in FIG. 2, the gaming machine configured as above has the shared display 203, the controller 100, and the gaming terminals 10.

(Shared Display 203)

The shared display 203 displays, as illustrated in FIG. 1, a virtual “Fishing Tournament” which is a JP game. The structure of the shared display 203 will be specifically discussed later.

(Gaming Terminal 10)

As illustrated in FIG. 2, each of the gaming terminals 10 includes a terminal display 101, a game starting unit 110, and a BET unit 111.

The terminal display 101 has a function of displaying a notifying image and an effect image for a base game and/or a chance game. The terminal display 101 includes base symbol arrangement areas 150a where base symbols 180 are arranged and JP symbol arrangement areas 150b where JP symbols are arranged. The game starting unit 110 has a function of outputting a game start signal in response to an operation by a player. The output game start signal is supplied to a later-detailed game running unit 103. The BET unit 111 has functions of receiving a BET in response to an operation by a player and outputting a BET signal. The output BET signal is supplied to the later-detailed game running unit 103.

(Controller 100)

As shown in FIG. 2, the controller 100 includes: a game running unit 103, a symbol memory 108, a timer 228, a JP chance memory 109, a display memory 107, and a display control unit 102.

The game running unit 103 runs a base game, triggered by the game start signal from the game starting unit 110. The base game is a game in which base symbols 180 are rearranged in the base symbol arrangement areas 150a of the terminal display 101. At the same time of running the base game, the game running unit 103 also runs a chance game in which JP symbols 180J are rearranged in the JP symbol arrangement areas 150b of the terminal display 101.

The symbol memory 108 stores the base symbols 180 and JP symbols 180J. The timer 228 specifies a timing at which a JP chance is awarded. The JP chance memory 109 functions as a chance flag memory which stores, for each gaming terminal 10, the number of JP chances awarded to a player in association with the timing of awarding the JP chance specified by the timer 228. The display memory 107 stores, as symbols to be displayed, the base symbols 180 and JP symbols 180J in the symbol memory 108. In addition, the display memory 107 stores effect image data for a base game and a chance game.

The display control unit 102 performs setting so that the base symbol arrangement areas 150a for arranging therein the base symbols 180 overlap the JP symbol arrangement areas 150b for arranging therein the JP symbols. Further, the display control unit 102 reads out base symbols 180 from the display memory 107 and displays the base symbols 180 in the base symbol arrangement areas 150a, under the control of the game running unit 103. The display control unit 102 also reads out JP symbols 180J from the display memory 107 and displays the JP symbols 180J in the JP symbol arrangement areas 150b, under the control of the game running unit 103.

The controller 100 includes a base game payout determining unit 105, a JP chance determining unit 106, and a payout awarding unit 104.

The base game payout determining unit 105, under the control of the game running unit 103, determines whether to award a payout of a base game on the basis of the relations among the base symbols 180 rearranged in the base symbol arrangement areas 150a. If it is determined that the payout is awarded, the base game payout determining unit 105 determines an amount of the payout and outputs a signal to the payout awarding unit 104.

The JP chance determining unit 106, under the control of the game running unit 103, determines whether to award a JP chance on the basis of the relations among the JP symbols 180J rearranged in the JP symbol arrangement areas 150b. If it is determined that a JP chance is awarded, the JP chance determining unit 106 determines the number of JP chances and outputs a signal to the JP chance memory 109.

The payout awarding unit 104 awards the payout of the base game determined by the base game payout determining unit 105. Further, the payout awarding unit 104 awards a payout of a JP game determined by a later-detailed JP game result determining unit 227, in response to a signal from the JP game result determining unit 227. Note that a JP game is run when the number of JP chances stored in the JP chance memory 109 for each gaming terminal equals or surpasses a predetermined number. Further, an amount of the payout of the JP game is determined by the later-detailed JP game result determining unit 227.

The controller 100 further includes: a JP game running unit 224, a JP order determining unit 229, a JP game memory 223, a JP game screen memory 222, and a shared display control unit 221.

The JP game running unit 224 determines, when predetermined time comes, whether the JP chance memory 109 stores a predetermined number or more of JP chances. This determination is made for each gaming terminal 10. The JP game running unit 224 runs a JP game on a gaming terminal 10 which stores the predetermined number or more of JP chances.

The JP order determining unit 229 determines the order in which gaming terminals participate in a JP game, based on a timing at which a JP chance is awarded. In other words, the JP order determining unit 229 determines in what order a result of a JP game is notified to the gaming terminals 10, based on a timing of awarding a JP chance.

In the present embodiment, the order in which a result of a JP game is notified to gaming terminals 10 is referred to as the order of participation in a JP game.

The JP game memory 223 stores therein information regarding the JP game. For example, the JP game memory 223 stores image data which is used for displaying, on the shared display 203, a line image arranged in a predetermined area and pointer images which indicate respective gaming terminals, arranged in accordance with the order of participation in a JP game, and move toward the line image. The JP game screen memory 222 stores therein display information based on the information of the JP game stored in the JP game memory 223.

The shared display control unit 221, under the control of the JP game running unit 224, reads out from the JP game screen memory 222 the display information which is based on the content of the JP game, and causes the shared display 203 to perform image displaying based on the display information.

The shared display control unit 221 causes the shared display 203 to display an image based on the order in which the gaming terminals 10 participate in a JP game, which has been determined by the JP order determining unit 229. Specifically, pointer images indicating the respective gaming terminals are arranged on the shared display 203 in accordance with the order of participation in a JP game, and these pointer images move toward a line image arranged in a predetermined area. This enables the players to visually and easily understand the order of participation in the JP game and also understand when the players participate in the JP game.

In addition to the above, the controller 100 includes a JP game result storage unit 230, a JP game result determining unit 227 and a progressive memory 226.

The JP game result storage unit 230 stores a rank determined by the JP game result determining unit 227 and a determined payout amount in association with one another.

Based on a result of a JP game, the JP game result determining unit 227 determines whether to award a payout of the JP game, under the control of the JP game running unit 224. In other words, whether a jackpot is met is determined. When it is determined that a jackpot is met, the JP game result determining unit 227 determines the rank of the payout (e.g. from four ranks). The JP game result determining unit 227 determines an amount of the payout according to the determined rank. The determination of whether a payout of a JP game is to be awarded is conducted for a number of times equal to the number of JP chances which each gaming terminal 10 has.

In case where the JP game result storage unit 230 stores a JP game result whose rank is identical with the rank determined by the JP game result determining unit 227, the JP game result determining unit 227 determines the payout of the JP game to be lower than the payout amount stored in the JP game result storage unit 230.

Ranks in this case are used for setting a payout. Specifically, a rank may be a ratio to a progressive value stored in the progressive memory 226 or a specific payout amount. For example, when ranks are ratios to a progressive value, the first rank is 50% of the progressive value, the second rank is 20% of the progressive value, the third rank is 5% of the progressive value, the fourth rank is 1% of the progressive value, and so on. In another example, when ranks indicate specific payout amounts, the first rank indicates 10,000 dollars, the second rank indicates 4,000 dollars, the third rank indicates 1,000 dollars, the fourth rank indicates 200 dollars, and so on. Alternatively, the determination of whether to award a payout of a JP game may be omitted, including a case where no payout is assigned to a rank. For example, the fourth rank may indicate “no payout”. In addition to the above, ranks may indicate predetermined ranges, respectively. For example, the first rank indicates a range of 40 to 50% of the progressive value.

The progressive memory 226 accumulatively stores a progressive value indicated by a progressive signal received from the controller 100. The progressive signal is transmitted from each gaming terminal 10 for the purpose of storing, as a payout of a JP game, a part of a game value consumed in a base game in the progressive memory 226.

Each block of the controller 100 may be realized with hardware or with software as needed.

(Operation of Controller 100)

The following describes an operation of the controller 100 in the above structure. First, the BET unit 111 receives a BET entered through an operation by a player. Further, a game start signal is output from the game starting unit 110 in response to the player's operation, and a base game and a chance game are run at the same time by the game running unit 103. When both of the games are run at the same time, the display control unit 102, under the control of the game running unit 103, displays base symbols 180 in the base symbol arrangement areas 150a. The display control unit 102 also displays JP symbols 180J in the JP symbol arrangement areas 150b, under the control of the game running unit 103.

Further, the base game payout determining unit 105 determines whether a payout is awarded, based on relations among the base symbols 180 rearranged in the base symbol arrangement areas 150a. If it is determined that a payout is awarded, the base game payout determining unit 105 determines an amount of the payout. The payout thus determined of the base game is awarded by the payout awarding unit 104.

The JP chance determining unit 106 determines whether to award a JP chance on the basis of the relations among the JP symbols 180J rearranged in the JP symbol arrangement areas 150b. If it is determined that JP chance is awarded, the JP chance determining unit 106 determines the number of JP chances to be awarded and stores the JO chance in the JP chance memory.

When the number of JP chances is stored in the JP chance memory, the JP chance determining unit 106 stores the number of JP chances in association with the timing specified by the timer 228. When the number of gaming terminals 10 is two or more, the number of JP chances may be stored in association with each gaming terminal 10.

At a predetermined timing, the JP game running unit 224 checks, for each gaming terminal 10, whether the JP chance memory 109 stores a JP chance. When there is a gaming terminal 10 storing a JP chance, a JP game is run at a gaming terminal 10 having a predetermined number or more of JP chances. Alternatively, it is possible to randomly determine the timing at which whether or not a JP chance is stored is determined and the JP game is run at a gaming terminal having a predetermined number or more of JP chances. Also, the timing at which the JP game starts may be notified by using the terminal display 101 or the like.

Then the JP game result determining unit 227 determines whether a jackpot is met, based on a result of the JP game. If it is determined by the JP game result determining unit 227 that a jackpot is met, the JP game result determining unit 227 determines the rank of the payout. The JP game result determining unit 227 checks whether a JP game result in the same rank is stored in the JP game result storage unit 230. If there is a JP game result in the same rank, a payout of the JP game is determined to be lower than the payout amount stored in the JP game result storage unit 230, based on the rank thus determined.

The determination of whether a jackpot is met and the determination of an amount of payout for the jackpot may be carried out when the JP game is run or when a JP chance is awarded to the player (i.e. when a JP chance is stored in the JP chance memory 109).

When the gaming machine is structured to include more than one gaming terminals 10, the JP order determining unit 229 determines the order in which the gaming terminals 10 participate in a JP game, based on a timing of awarding a JP chance.

Furthermore, the shared display 203 displays an image based on a timing to run a JP game. For example, the shared display 203 displays a pointer image which is arranged at a part corresponding to a timing to run a JP game and which moves toward a line image arranged in a predetermined area. In addition to the above, the shared display 203 notifies a result of a JP game in which a player participates by consuming a JP chance stored in the JP chance memory 109, in accordance with a timing at which the pointer image reaches the line image. Alternatively, the shared display 203 may display images based on the order in which the gaming terminals 10 participates in a JP game, which order has been determined by the JP order determining unit 229. Alternatively, the aforesaid arrangements may be combined.

When the result of the JP game is notified, the payout awarding unit 104 awards a payout of the JP game.

(Display States)

Now, the following discusses an example where the gaming machine is specifically embodied as a gaming machine 1.

A gaming machine 1 is placed in a gaming facility such as a casino. This gaming machine 1 runs a unit game which involves a game medium. The game medium is a coin, bill, or a value in the form of electronic information. However, the game medium in the present invention is not particularly limited. For example, a medal, token, electronic money, ticket or the like are also possible. Further, the ticket is not particularly limited and may be a later-described ticket with a barcode or the like ticket.

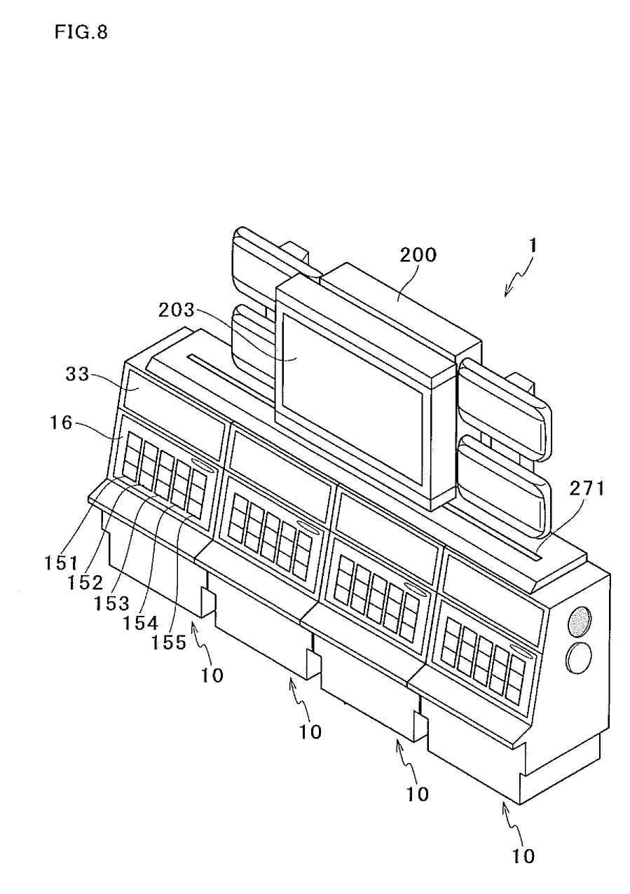

As illustrated in FIG. 8, the gaming machine 1 includes: gaming terminals 10 which run a base game independently from each other (the number of gaming terminals 10 is 4 in the present embodiment); a center control unit 200 connected to the gaming terminals 10, which is in communication with the gaming terminals 10 and runs a JP game; a shared display 203 which displays thereon an effect image related to the JP game; a rail 271 which allows the shared display 203 to move to a position immediately above one of the gaming terminals 10; and a not-illustrated drive motor 270.

In addition, each gaming terminal 10 has an upper image display panel 33 and a lower image display panel 16. The lower image display panel 16 and the upper image display panel 33 function as the above-discussed terminal display 101. A payout of a JP game is configured to be higher than that of a base game.

(Display States of Lower Image Display Panel 16)

Now, referring to FIG. 3, the display states of the lower image display panel 16 in a base game and a chance game are specifically described. The lower image display panel 16 is structured to arrange symbols in accordance with video reel. The lower image display panel 16 may have a mechanical structure adopting a reel device which rotates a reel to arrange symbols. Alternatively, the lower image display panel 16 may have an electric structure in which symbols are arranged by a video reel displayed as an image. Further, the lower image display panel 16 may adopt a combination of the mechanical structure (reel) and the electrical structure (video reel).

As shown in FIG. 3, the lower image display panel 16 displays a matrix-configured matrix 156, when a base game and a chance game are run at the same time. The matrix 156 is displayed at the center of the lower image display panel 16, and base symbols 180 and JP symbol 180J are arranged therein. Further, the matrix 156 is provided with display windows 151 to 155. In the display windows 151 to 155, a symbol column having base symbols 180 and a symbol column having JP symbols 180J are scrollably displayed. These columns overlap each other. The display windows 151 to 155 are respectively divided into upper stages 151a to 155a, central stages 151b to 155b, and lower stages 151c to 155c. The base symbols 180 and the JP symbols 180J are stopped (arranged) in each of the stages 151a to 155a, 151b to 155b, and 151c to 155c so that a base symbol 180 overlaps a JP symbol 180J.

For example, in FIG. 3, a “Clownfish” 181 which is a base symbol 180 is stopped in a base symbol arrangement area 150a in the upper stage 151a of the display window 151, and a “GET” which is a JP symbol 180J is stopped in the JP symbol arrangement area 150b of the same stage. Further, an “Angelfish” 182 is stopped in the base symbol arrangement area 150a in the central stage 151b of the display window 151, and no symbol is stopped in the JP symbol arrangement area 150b of the same stage. Further, a “Clownfish” is stopped in the base symbol arrangement area 150a in the bottom stage 151c of the display window 151, and a “GET” which is a JP symbol 180J is stopped in the JP symbol arrangement area 150b of the same stage. In short, the matrix 156 is a symbol matrix including five columns and three rows. The matrix 156 however is not limited to the one with the five-columns and three-rows.

In the upper-right part of the lower image display panel 16, a JP chance display area 160 is displayed as illustrated in FIG. 3. JP chance display area 160 displays the number of JP chances that a player currently has. For example, in FIG. 3, the number of JP chances is “1”. As such, a player is able to join the JP game only once to be subjected to a process of determining whether a payout is awarded.

As illustrated in FIG. 3, the base symbols 180 and the JP symbols 180J are arranged so as to overlap one another in the lower image display panel 16, when a base game and a chance game are run at the same time in the gaming terminal 10. Specifically, as shown in the lower part of FIG. 3, a JP symbol 180J is arranged in the JP symbol arrangement area 150b below each base symbol arrangement area 150a.

As such, the base symbols 180 and the JP symbols 180J are concurrently arranged on the matrix 156 in the lower image display panel 16 to indicate results of a base game and a chance game. In this way a base game and a chance game can be run at the same time.

In a base game, base symbols 180 are arranged and a payout is awarded in accordance with the arrangement of the base symbols 180. In the case of FIG. 3, “Clownfish” 181 which is a base symbol 180 is displayed in each of the upper stage 151a of the display window 151, the upper stage 152a of the display window 152, and the upper stage 153a of the display window 153. As a result of this, a winning combination of “Clownfish” 181 is met in the base game, and a payout according to this winning combination is awarded.

In a chance game, arranged are only JP symbols 180J. In the case of FIG. 3, “GET” is displayed in each of the upper stage 151a of the display window 151, the lower stage 151c of the display window 151, the lower stage 153c of the display window 153, and the central stage 154d of the display window 154. As a result of the above 4 JP symbols are arranged. In the present embodiment, a JP chance is awarded when three or more JP symbols 180J are arranged. Therefore the number of JP chance is increased in the case above. As the number of JP chances is increased, the JP chance display area 160 is updated.

Because of the above, the gaming machine 1 provides a new entertainment characteristic of allowing a player to play a chance game as well as a base game at the same time.

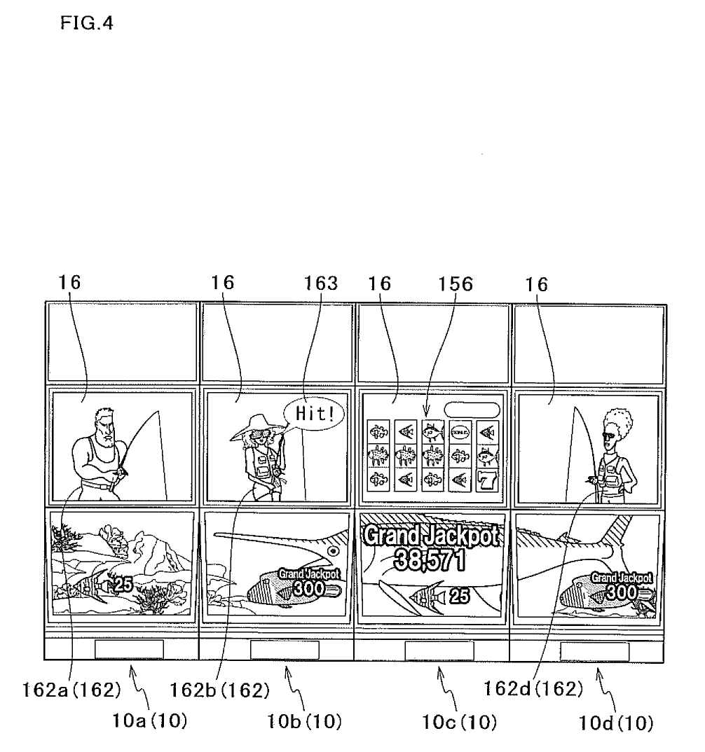

As illustrated in FIG. 4, the lower image display panels 16 of the respective gaming terminals 10 (gaming terminals 10a-10d) participating in a JP game display character images 162 (162a-162d) associated with the respective gaming terminals 10. The character images 162 depict different characters which are fishing and correspond to the respective gaming terminals 10.

JP game is run at a predetermined timing. The JP game however is not run for a gaming terminal 10 having no JP chances. For example, the gaming terminal 10c is running not a JP game but a base game, in the case of FIG. 4. On the other hand, a JP game is run in each of the remaining 3 gaming terminals 10 (gaming terminal 10a, gaming terminal 10b, and gaming terminal 10d).

For gaming terminals 10 not participating in the JP game, no character image 162 is displayed. For example, in FIG. 4 the gaming terminal 10c cannot participate in the JP game because no JP chance has been awarded thereto. Therefore the lower image display panel 16 of the gaming terminal 10c does not display a character image 162.

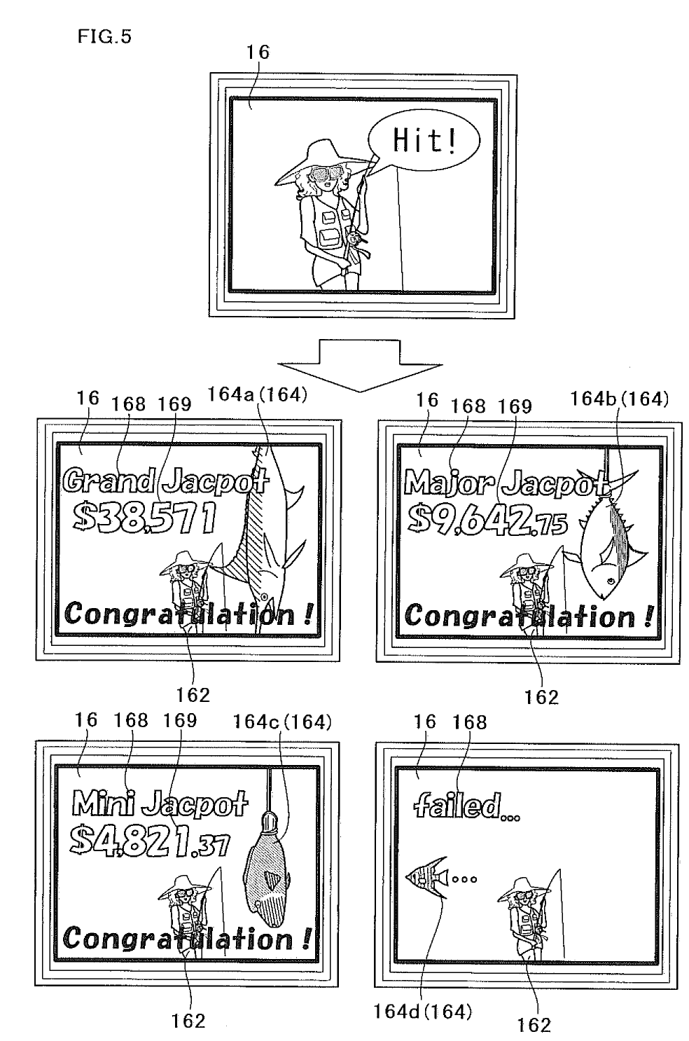

When a JP game is run, the lower image display panels 16 display comment images 163 in the vicinity of the character images 162, in the temporal order of obtaining JP chances. Each comment image 163 shows a comment of a character image 162 in such a way that a text “Hit!” is shown in a speech bubble area. For instance, as illustrated in FIG. 4 and the upper part of FIG. 5, when the gaming terminal 10b has a turn in a JP game, a comment image 163 is displayed in the vicinity of the character image 162b displayed on the lower image display panel 16 of the gaming terminal 10b.

In this way, a comment image 163 is displayed in the vicinity of the character image 162 associated with each gaming terminal 10. A player can therefore understand that his/her turn has come in a JP game.

Thereafter the gaming terminal 10 for which the comment image 163 is displayed is notified of a rank and a payout amount as a result of the JP game. The result of the JP game is one of four ranks of payout. Specifically, the ranks are “Grand Jackpot”, “Major Jackpot”, “Mini Jackpot”, and “Lose”, in the descending order of payout amounts.

Specifically, “Grand Jackpot” is a rank in which 40% of an accumulative progressive value is awarded as a result of a JP game. “Major Jackpot” is a rank in which 10% of an accumulative progressive value is awarded as a result of a JP game. “Mini Jackpot” l is a rank in which 5% of a progressive value is awarded as a result of a JP game. No payout is awarded in the case of “Lose”.

It is noted that a progressive value is assumed to be 1000 dollars even if the progressive value is actually less than 1000 dollars. Because of this, 200 dollars are awarded even when a jackpot which has been met is “Mini Jackpot”, and hence a player may be motivated to continue the game.

Referring to FIG. 5, a result of a JP game displayed on the lower image display panel 16 is discussed. The lower image display panel 16 displays, as a result of a JP game, a character image 162, a payout image 164, a rank image 168, and a payout amount image 169.

The rank image 168 is a text image indicating a determined rank. The payout amount image 169 is a text image indicating a payout amount determined according to the determined rank. The payout image 164 is an image of a fish which changes in accordance with the rank.

The lower part of FIG. 5 shows a state of a result of a JP game, which is displayed on the lower image display panel 16 of the gaming terminal 10b. Displayed on the upper-left screen in the lower part of FIG. 5 is a display state of the lower image display panel 16 when the rank “Grand Jackpot” results from a JP game. As shown in the upper-left screen in the lower part of FIG. 5, as a payout image 164 corresponding to the rank “Grand Jackpot”, a payout image 164a showing a marlin is displayed with a character image 162b. The upper-right screen in the lower part of FIG. 5 shows a display state of the lower image display panel 16 when the rank “Major Jackpot” results from a JP game. As shown in the upper-right screen in the lower part of FIG. 5, as a payout image 164 corresponding to the rank “Major Jackpot”, a payout image 164b showing a tuna is displayed with a character image 162b. The lower-left screen in the lower part of FIG. 5 shows a display state of the lower image display panel 16 when the rank “Mini Jackpot” results from a JP game. As shown in the lower-left screen in the lower part of FIG. 5, as a payout image 164 corresponding to the rank “Mini Jackpot”, a payout image 164c showing a napoleon fish is displayed with a character image 162b. The lower-right screen in the lower part of FIG. 5 shows a display state of the lower image display panel 16 when a rank as a result of a JP game is “Lose”. As shown in the lower-left screen in the lower part of FIG. 5, as a payout image 164 corresponding to the rank “Lose”, a payout image 164d showing an angelfish is displayed with a character image 162b. As shown in FIG. 5, an image of a fish in the payout image 164 is changed in accordance with the rank. It is noted that an embodiment of images displaying a result of a JP game is not limited to the above.

In addition to the above, the sizes of the payout images 164 are made different in accordance with timings to participate in a JP game, even if the rank is identical. For example, even if the same rank “Mini Jackpot” is achieved, payout amounts are made different in accordance with the order of achieving the rank. Specifically, even if the same rank “Mini Jackpot” is achieved, a player who achieved the rank first receives a higher payout amount than a player who achieved the rank second. Therefore, as illustrated in FIG. 1, the size of the payout image 164 indicating the rank is arranged to be small as compared to a case where a payout amount is higher even if the rank is the same.

In this way, a payout awarded as a result of a JP game is determined by (i) a rank determined according to a result of the JP game, (ii) a timing to run the JP game, and (iii) a game value accumulatively stored in the payout memory. Specifically, a player for whom a JP game is run earlier than for another player receives a higher payout, even if the rank of these players is the same. This provides players with a new entertainment characteristic.

Furthermore, since a timing to run a JP game is displayed on the display, a player is motivated to continue a game thanks to decreased stress on him/her.

(Display States of Shared Display 203)

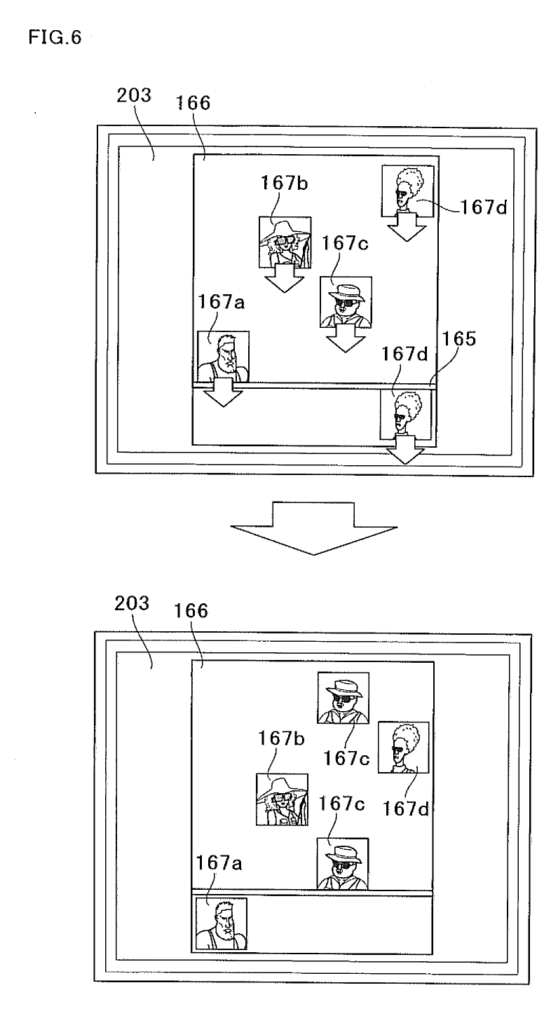

Referring to FIG. 6, the following specifically describes an example of display states of the shared display 203 in the operation process in accordance with the above-described gaming machine 1 and playing method. As illustrated in FIG. 6, players of respective gaming terminals 10 (gaming terminal 10a to gaming terminal 10d) can see that a JP game is displayed on the shared display 203.

When the JP game starts, the shared display 203 displays pointer images 167 (pointer images 167a to 167d). These pointer images 167 indicate the respective gaming terminals 10. That is to say, the pointer image 167a indicate the gaming terminal 10a, the pointer image 167b indicate the gaming terminal 10b, the pointer image 167c indicate the gaming terminal 10c, and the pointer image 167d indicate the gaming terminal 10d. In this example, the pointer image 167 specifically indicates the face part of the character image 162.

The shared display 203 has a pointer display area 166. As illustrated in FIG. 6, the pointer display area 166 is provided at the center of the shared display 203. The pointer display area 166 is a display area where a pointer image 167 indicating each gaming terminal 10 is displayed. Further displayed in the pointer display area 166 is a line-shaped line image 165 which horizontally extends in the lower part in such a way as to traverse the pointer display area 166.

The pointer images 167 are arranged in accordance with the order in which the gaming terminals 10 participate in a JP game. Specifically, the pointer images 167 are arranged from the bottom to the top, in accordance with the temporal order of participation.

The displayed pointer images 167 are, as illustrated in FIG. 6, scrolled downward over time. In other words, the pointer images 167 move toward the line image 165, reach the line image 165, and then pass over the line image 165.

The notification of a result of a JP game is carried out when a pointer image 167 reaches the line image 165. Specifically, the notification of a payout of a JP game is carried out in such a way that, when a pointer image 167 reaches the line image 165, the lower image display panel 16 of the gaming terminal associated with that pointer image 167 displays a comment image 163 in the vicinity of the character image 162, and then displays a payout image 164. Along with the notification of the payout, the payout is awarded.

In this way character images 162 associated with the respective gaming terminals 10 are displayed on the shared display 203 viewable from the gaming terminals 10, and this allows players to share a sense of participation. This provides a player with a new entertainment characteristic.

Although the present embodiment presupposes that JP game is a fishing game, JP game may be another type of game such as a hunting game. It is also noted that the pointer images 167 and the line image 165 are not necessarily displayed in the manner as above. It is also noted that the pointer images 167 are not necessarily arranged as above. It is also noted that the pointer images 167 do not necessarily move in the manner as above. For example, the pointer images 167 may move in the crosswise direction or upward.

(Symbols, Winning Combination, etc)

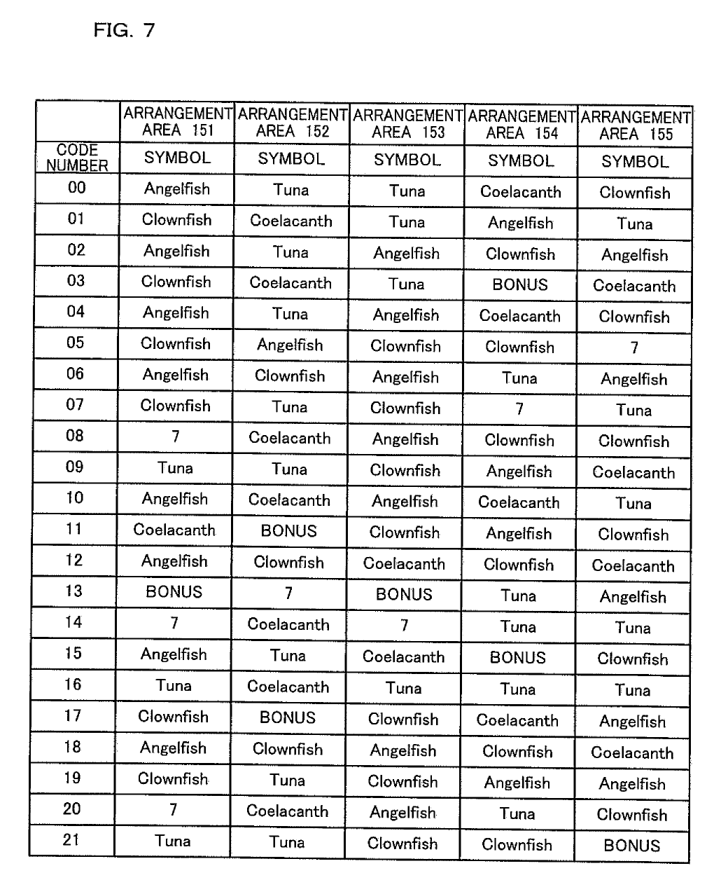

The base symbols 180 displayed in the matrix 156 on the lower image display panel 16 are arranged so that 22 symbols constitute a single symbol column as illustrated in FIG. 7. To each of the symbols constituting the columns is given one of code numbers 0 to 21. Each of the symbol columns has a combination of symbols including “Angelfish” 182, “Clownfish” 181, “7” 185, “Tuna” 183, “Coelacanth” 184, and “BONUS” 186. As illustrated in FIG. 3, the base symbols 180 are arranged in the respective base symbol arrangement areas 150a of the symbol columns.

Three successive symbols in the symbol columns are displayed (arranged) in the upper stages 151a to 155a, the middle stages 151b to 155b, and the lower stages 151c to 155c of the display windows 151 to 155, so that the symbols form a symbol matrix having five columns and three rows in the display windows 151 to 155. When a BET button and a start button are sequentially pressed in this order to start a game, symbols constituting the symbol matrix start to scroll. This scrolling of the symbols stops (rearrangement) after a predetermined period from the beginning of the scrolling.

For each base symbol 180 a winning combination has been determined in advance. A winning combination is arranged such that a state advantageous for a player is achieved when at least a predetermined number of symbols are successively displayed on one of paylines L of the matrix 156. For example, the advantageous states include: a state where coins corresponding to a winning combination are paid out, a state where the number of coins to be paid out is added to a credit, and a state where a bonus game is started. The payline L will be discussed later.

For example, when three or more symbols of “Clownfish” 181 are rearranged on the payline L, five coins are paid out for each BET or a credit corresponding to five coins is added. In short, game media (game values) are awarded.

In another case, for example, when three or more symbols of “BONUS” are rearranged on the payline L, a bonus is triggered and the gaming state shifts from a base game to a bonus game. When four or more “BONUS” symbols are stopped on the matrix 156, 20 coins (game media) are paid out for each BET.

Here, a bonus game is a gaming state which provides a larger advantage than a base game. In this embodiment, the bonus game is a free game. The free game is a game allowing a player to play a game for a predetermined number of times without betting a coin. No particular limitation is put on the bonus game, as long as it is a gaming state advantageous to the player, that is, it is more advantageous than the base game. For example, the bonus game may include a state where more game media are obtainable than in the base game, a state where a game medium is obtainable with higher probability than in the base game, a state where a game medium is less consumed than in the base game, and the like. Specifically, a free game, a second game, a feature game, and the like may be mentioned as examples of the bonus game.

The lower image display panel 16 displays three activated paylines L as illustrated in FIGS. 3. The “payline L” is used for determining a winning combination of the base symbols 180. That is, when the base symbols 180 are rearranged on and out of the payline L, a combination is determined for only the base symbols 180 rearranged on the payline. When the combination is recognized as a winning combination in consequence of the determination, an advantageous state of the player is established in accordance with the winning combination. That is to say, coins are paid out in accordance with the winning combination, the number of coins to be paid out is added to a credit, or a bonus game is started, for example. Note that, not limited to three, the number of paylines L maybe one, two, four, or more. When the number of paylines L is two or more, the number of paylines L activated may be determined according to a predetermined condition, such as the number of coins placed as a BET. In this case, the number of activated paylines L may be notified by a lamp or the like.

As illustrated in FIG. 3, the paylines L include a top line 161a traversing the upper stages 151a, 152a, 153a, 154a, and 155a, a central line 161b traversing the central stages 151b, 152b, 153b, 154b, and 155b, and a bottom line 161c traversing the lower stages 151c, 152c, 153c, 154c, and 155c. When three or more base symbols 180 are successively rearranged on at least one of the paylines 161a to 161c, it is determined that a winning combination is met. For example, in the case of FIG. 3, a winning combination of “Clownfish” has been met because three symbols of “Clownfish” 181 are successively rearranged on the top line 161a of the display windows 151 to 153.

The JP symbols 180 are “scatter symbols” which are such symbols which provide a JP chance to a player when a predetermined number or more (e.g. three) of them are displayed in the matrix 156. For example, in the case of FIG. 3, the JP symbols 180J are arranged on the upper stage 151a and the lower stage 151c of the display window 151, the lower stage 153c of the display window 153, and the central stage 154b of the display window 154. Since four JP symbols 180J are arranged in this case, a JP chance is awarded to a player.

In this way, a result of a base game is determined according to whether base symbols 180 are successively rearranged on a payline L, whereas a result of a chance game is determined according to whether there are a predetermined number or more of rearranged JP symbols 180J. As such, a base game and a chance game are similar slot games but adopt different methods of determining a result. Therefore a player may be possible to easily grasp the results of any games. This may release the stress of the player. The method of how to determine results of a base game and a chance game is not limited to the above. Both of them may be obtained by the scatter symbol method or by the winning combination method. Alternatively, a result of a base game is determined by the scatter symbol method whereas a result of a chance game is determined by the winning combination method.

The lower image display panel 16 may further display a credit value indicator and a payout value indicator. The credit value indicator displays a total value (hereinafter also referred to as total credit value) which a gaming terminal 10 can pay out to a player. The payout value indicator displays the number of coins to be paid out, when a predetermined number or more of base symbols 180 are successively rearranged on a payline L.

(Mechanical Structure of Gaming Machine 1)

As illustrated in FIG. 8, the gaming machine 1 includes: gaming terminals 10 which run a base game independently from each other (the number of gaming terminals 10 is 4 in the present embodiment); a center control unit 200 connected to the gaming terminals 10, which is in communication with the gaming terminals 10 and runs a JP game; a shared display 203 which displays thereon an effect image related to the JP game; a rail 271 which allows the shared display 203 to move to a position immediately above one of the gaming terminals 10; and a not-illustrated drive motor 270.

Four gaming terminals 10 are laterally arranged in a parallel manner, with their terminal displays 101 (each including the lower image display panel 16 and the upper image display panel 33) facing forward. The rail 271 is arranged so as to cover the four gaming terminals 10. The shared display 203 is arranged on the rail 271 and its screen faces in the same direction as the terminal displays 101. The shared display 203 is arranged to be reciprocally movable by the drive motor 270. The center control unit 200 has, though unillustrated, electric or mechanical members for running a JP game and a cabinet to store these members. The center control unit 200 is arranged behind the shared display 203.

Although in the present embodiment the functions of the controller 100 are realized by the gaming terminals 10 and the center control unit 200, the present invention is not limited to this arrangement.

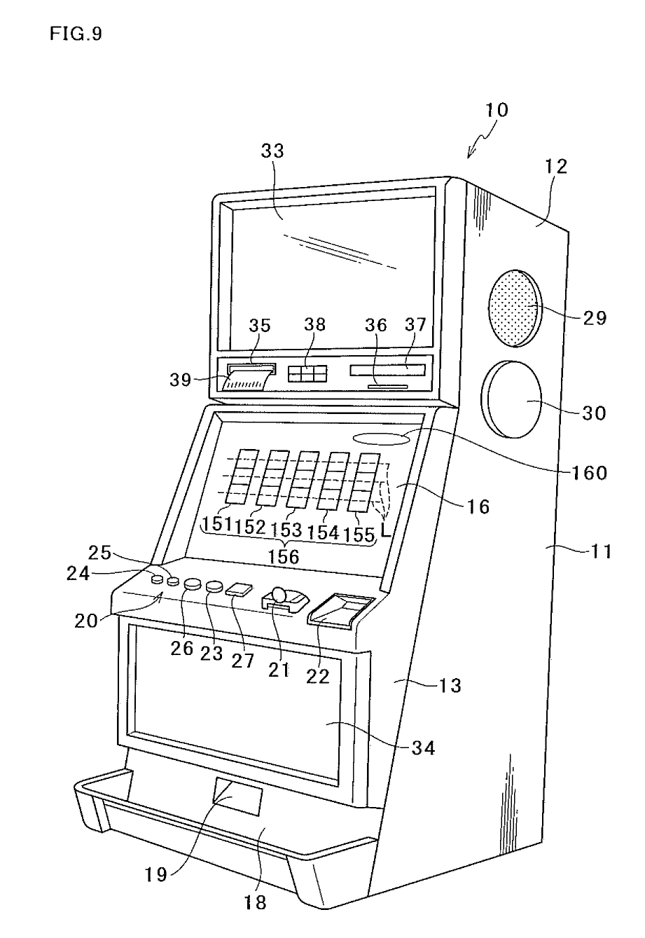

As illustrated in FIG. 9, the gaming terminal 10 includes: a cabinet 11, a top box 12 provided above the cabinet 11, and a main door 13 provided on the front surface of the cabinet 11. The main door 13 is provided with the lower image display panel 16. The lower image display panel 16 includes a transparent liquid crystal panel which displays various types of information. The lower image display panel 16 displays display windows 151 to 155 and a matrix 156 for arranging therein base symbols 180 and JP symbols 180J. Further, the lower image display panel 16 displays as needed various types of information and effect images related to games. Displayed in the upper-right part of the lower image display panel 16 is a JP chance display area 160.

This embodiment deals with a case where the lower image display panel 16 electrically displays base symbols 180 and JP symbols 180J in such a way that a base symbol 180 overlaps a JP symbol 180J, with the result that the symbols are arranged in five rows/three columns. However, the present invention is not limited to this.

Below the lower image display panel 16 provided are a control panel 20, a coin insertion slot 21, and a bill validator 22. The control panel 20 has buttons 23 to 27. These buttons 23 to 27 allow a player to input instructions related to a game played by the player. Through the coin insertion slot 21, a coin is received in the cabinet 11.

The control panel 20 includes: a spin button 23, a change button 24, a cashout button 25, a 1-BET button 26, and a maximum BET button 27. The spin button 23 is for inputting an instruction to start symbol scrolling. The change button 24 is used to ask a staff person in the gaming facility for exchange of money. The cashout button 25 is for inputting an instruction to pay out coins corresponding to the total credit value into the coin tray 18, via a coin payout opening 19.

The 1-BET button 26 is used for betting one coin out of those corresponding to the total credit value. The maximum BET button 27 is used for betting, out of those corresponding to the total credit value, a maximum number of coins (e.g., fifty coins) which can be bet in one game. Note that the number of coins corresponding to 1 BET is not limited to the above.

The bill validator 22 validates whether bill is genuine or not and receives the genuine bill into the cabinet 11. Note that the bill validator 22 is capable of reading a later-mentioned ticket 39 having a barcode. When the bill validator 22 reads the ticket 39, it outputs to the main CPU 41 a read signal representing information having read from the barcode.

On the lower front surface of the main door 13, that is, below the control panel 20, a berry glass 34 is provided. On the belly glass 341 a character of a gaming terminal 10 or the like is drawn. On the front surface of top box 12 is provided an upper image display panel 33. The upper image display panel 33 has a liquid crystal panel and displays an effect image, introduction to the game, rules of the game, or the like.

Further, the top box 12 has a speaker 29 for performing an audio output and a lamp 30. Below the upper image display panel 33 are provided a ticket printer 35, a card reader 36, a data displayer 37, and a keypad 38. The ticket printer 35 prints, on to a ticket, a barcode having encoded data containing credit-value, date and time, identification number of a gaming terminal 10 or the like, thereby issuing a ticket 39 having a barcode attached thereto. A player can play a game in another gaming terminal 10 with the ticket 39 having the barcode, or exchange the ticket 39 with bill or the like at a change booth or the like of the game arcade.

The card reader 36 reads/writes data from/into a smart card. The smart card is carried by a player, and stores therein data for identifying the player, data relating to a history of games played by the player, or the like.

The data displayer 37 includes a fluorescent display or the like, and displays the data read by the card reader 36 and the data input by the player through the keypad 38. The keypad 38 is for entering instructions or data relating to issuing of a ticket or the like.

(Electrical Structure of Gaming Machine 1)

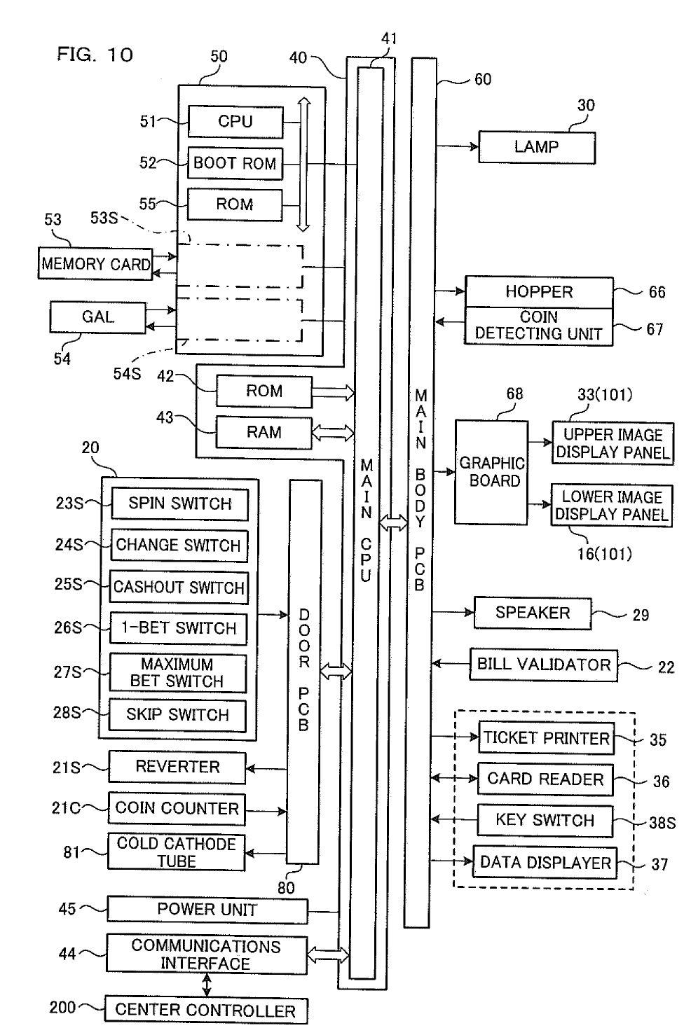

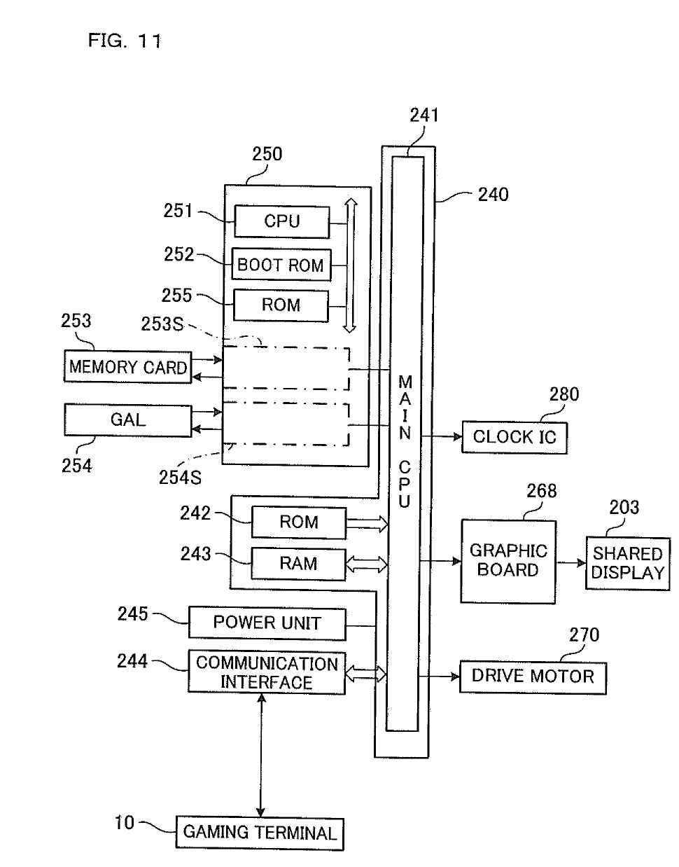

FIGS. 10 and 11 are block diagrams each illustrating an electrical structure of the entire gaming machine 1.

(Electrical Structure of Gaming Terminal 10)

FIG. 10 is a block diagram illustrating an electrical structure of the gaming terminal 10. As illustrated in FIG. 10, the cabinet 11 includes therein a control unit having at least one of the functions of a controller 100. The control unit includes, as shown in FIG. 10, a motherboard 40, a main body PCB (Printed Circuit Board) 60, a gaming board 50, a door PCB 80, various switches, sensors, or the like.

The gaming board 50 is provided with a CPU (Central Processing Unit) 51, a RON 55, a boot ROM 52, a card slot 53S corresponding to a memory card 53, and an IC socket 54S corresponding to a GAL (Generic Array Logic) 54. The CPU 51, the ROM 55, and the boot ROM 52 are connected to one another through an internal bus.

The memory card 53 stores therein a game program and a game system program. The game program contains a stop symbol determining program. The stop symbol determining program is a program for determining: base symbols 180 (code numbers corresponding to the symbols) to be stopped in the base symbol arrangement area 150a; and JP symbols 180J (code numbers corresponding to the symbols) to be stopped in the JP symbol arrangement area 150b. This stop symbol determining program contains sets of symbol weighting data respectively corresponding to various payout rates (e.g., 80%, 84%, 88%). Each set of the symbol weighting data indicates, for each of the display windows 151 to 155, a code number of each symbol and at least one random numerical value allotted to the code number. The numerical value is a value within a predetermined range of 0 to 256 for example.

The payout rate is determined based on payout rate setting data output from the GAL 54. Based on a set of the symbol weighting data corresponding to the payout rate determined, a symbol to be stopped is determined.

The memory card 53 stores therein various types of data for use in the game programs and the game system programs. For example, data listing combinations of a base symbol 180 to be displayed on the display windows 151 to 155 of FIG. 3 and an associated range of random numerical values is stored in the form of a table. This data is transferred to the RAM 43 of the motherboard 40, at the time of running a game program.

The card slot 53S is structured so as to allow the memory card 53 to be attached/detached to/from the card slot 53S. This card slot 53S is connected to the motherboard 40 through an IDE bus. Thus, the type and content of a game run by a gaming terminal 10 can be modified by detaching the memory card 53 from the card slot 53S, write a different game program and a different game system program into the memory card 53, and inserting the memory card 53 back into the card slot 53S.

Each of the game programs includes a program related to the progress of the game and/or a program for causing a transition to a bonus game. Each of the game programs Includes image data and audio data output during the game.

The GAL 54 has input and output ports. When the GAL 54 receives data via the input port, it outputs data corresponding to the input data from its output port. This data from the output port is the payout rate setting data described above.

IC socket 54S is structured so as to allow the GAL 54 to be attached/detached to/from the IC socket 545 The IC socket 54S is connected to the motherboard 40, via a PCI bus. Thus, the payout rate setting data to be output from GAL 54 can be modified by: detaching the GAL 54 from the IC socket 54S, overwriting the program stored in the GAL 54, and attaching the GAL 54 back to the IC socket 54S.

The CPU 51, the RON 55 and the boot ROM 52 connected through an internal bus are connected to the motherboard 40 through the PCI bus. The PCI bus communicates signals between the motherboard 40 and the gaming board 50 and supplies power from the motherboard 40 to the gaming board 50. The ROM 55 stores country identification information and an authentication program. The boot ROM 52 stores a preliminary authentication program and a program (boot code) for enabling the CPU 51 to run the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication program to be authenticated is not falsified. In short, the preliminary authentication program authenticates the authentication program.

The motherboard 40 is provided with a main CPU 41, a ROM (Read Only Memory) 42, a RAM (Random Access Memory) 43, and a communication interface 44.

The main CPU 41 has at least one of the functions of a controller 100 controlling the entire gaming machine 1, and the main CPU 41 controls a gaming terminal 10. In particular, the main CPU 41 controls the following operations: an operation of outputting a signal instructing variable-displaying of symbols 180 to the graphic board 68, which is performed in response to pressing of the spin button 23 after betting of credit; an operation of determining symbols 180 to be stopped after the variable-displaying of symbols 180; and an operation of stopping the symbols 180 thus determined in the display window 151 to 155.

In other words, the main CPU 41 serves as an arrangement controller which arranges symbols to form a new symbol matrix through scrolling of symbols displayed on the lower image display panel 16. This main CPU 41 therefore determines symbols to be arranged in a symbol matrix by selecting symbols to be arranged from various kinds of symbols. Then, the main CPU 41 executes arrangement control to stop scrolling the symbols to present the symbols thus determined.

The ROM 42 stores a program such as BIOS (Basic Input/Output System) run by the main CPU 41, and permanently-used data. When the BIOS is run by the main CPU 41, each of peripheral devices is initialized and the game program and the game system program stored in the memory card 53 are read out through the gaming board 50. The RAM 43 stores data or a program used for the main CPU 41 to perform a process.

In addition, the ROM 42 stores a gaming terminal ID unique to each gaming terminal 10. When various signals are transmitted to the center control unit 200, the center control unit 200 can identify the senders of these signals, because gaming terminal ID information is added to the header of the like of each signal. A gaming terminal ID is, for example, an IP (Internet Protocol) address of each gaming terminal 10.

In addition to the above, the RAM 43 stores a JP timing which is based on a JP timing signal transmitted from the center control unit 200. This JP timing is information regarding timing to start a JP game, and is determined after a JP game finishes in the center control unit 200. The JP timing signal is a signal including information generated based on the JP timing, and this signal is transmitted from the center control unit 200.

In the RAM 43, furthermore, image data is stored that is used for displaying a character image 162, a comment image 163, a payout image 164, a line image 165, a pointer image 167 or the like on the lower image display panel 16.

The communication interface 44 is provided to communicate with a host computer and the like equipped in the gaming facility, through a communication line. The communication interface 44 is also used for performing communication with the center control unit 200 over a communication line. Further, a main body PCB (Printed Circuit Board) 60 and a door PCB 80 are connected to the motherboard 40, through USB (Universal Serial Bus). Further, the motherboard 40 is connected to a power unit 45. The power unit 45 supplies power to the motherboard 40 to boot the main CPU 41 thereof. Meanwhile, the power unit 45 supplies power to the gaming board 50 through the PCI bus to boot the CPU 51.

The main body PCB 60 and door PCB 80 are connected to various devices or units which generate signals to be input to the main CPU 41, and various devices or units whose operations are controlled by signals from the main CPU 41. Based on a signal input to the main CPU 41, the main CPU 41 runs the game program and the game system program stored in the RAM 43, to perform an arithmetic process. Then, the CPU 41 stores the result of the arithmetic process in the RAM 43, or transmits a control signal to the various devices and units to control them based on the result.

The main body PCB 60 is connected with a lamp 30, a hopper 66, a coin sensor 67, a graphic board 68, the speaker 29, a bill validator 22, a ticket printer 35, a card reader 36, a key switch 38S, and a data displayer 37.

The lamp 30 is turned on/off on the basis of a control signal from the main CPU 41.

The hopper 66 is mounted in the cabinet 11 and pays out a predetermined number of coins from a coin outlet 19 to the coin tray 18, based on a control signal from the main CPU 41. The coin sensor 67 is provided inside the coin outlet 19, and outputs a signal to be input to the main CPU 41 upon sensing that a predetermined number of coins have been delivered from the coin outlet 19.

The graphic board 68 controls image displaying of upper image display panel 33 and the lower image display panel 16, based on a control signal from the main CPU 41. Further, the graphic board 68 is provided with a VDP (Video Display Processor) for generating image data on the basis of a control signal from the main CPU 41, a video RAM for temporarily storing the image data generated by the VDP, or the like. Note that image data used at the time of generating the image data by the VOP is in a game program which is read out from the memory card 53 and stored in the RAM 43.

The bill validator 22 reads an image on the bill and takes only those recognized as to be genuine into the cabinet 11. When taking in a genuine bill, the bill validator 22 outputs an input signal indicating the value of the bill to the main CPU 41. The main CPU 41 stores into the RAM 43 a credit-value corresponding to the value of the bill indicated by the signal.

The ticket printer 35 prints a barcode on to a ticket to issue a ticket 39 having the barcode. The barcode contains encoded data such as credit-value stored in the RAM 43, date and time, identification number of the gaming terminal 10, or the like, based on a control signal from the main CPU 41.

The card reader 36 reads out data from the smart card and transmits the data to the main CPU 41. Further, the card reader 36 writes data into the smart card based on the control signal output from the main CPU 41. The key switch 38S is mounted to the keypad 38, and outputs a signal to the main CPU 41 in response to an operation of the keypad 38 by the player. The data displayer 37 displays, based on a control signal from the main CPU 41, the data read by the card reader 36 or the data input by the player through the keypad 38.

The door PCB 80 is connected to a control panel 20, a reverter 21S, a coin counter 21C, and a cold cathode tube 81. The control panel 20 is provided with: a spin switch 23S associated with the spin button 23; a change switch 24S associated with the change button 24; a cashout switch 258 associated with the cashout button 25; a 1-BET button switch 26S associated with the 1-BET button 26; and a maximum BET switch 27S associated with the maximum BET button 27. Each of the switches 23S to 27S outputs an input signal to the main CPU 41, when a player presses the associated button.

The coin counter 21C is provided within the coin insertion slot 21, and identifies whether the coin inserted into the coin insertion slot 12 by the player is genuine. A coin except the genuine coin is discharged from the coin outlet 19. In addition, the coin counter 21C outputs an input signal to the main CPU 41 upon detection of a genuine coin.

The reverter 21S is operated on the basis of the control signal output from the main CPU 41 and distributes a coin, which is recognized as a genuine coin by the coin counter 21C, to a not-illustrated cash box or hopper 66 mounted in the gaming terminal 10. In other words, when the hopper 66 is full of the coins, the genuine coin is distributed into the cash box by the reverter 21S. On the other hand, when the hopper 66 is not yet full with the coins, the genuine coin is distributed into the hopper 66. The cold cathode tube 81 functions as a backlight mounted to rear sides of the lower image display panel 16 and the upper image display panel 33. This cold cathode tube 81 turns on according to a control signal from the main CPU 41.

(Electrical Structure of Center Control Unit 200)

FIG. 11 is a block diagram showing the electrical structure of the center control unit 200. Disposed in the center control unit 200 is a control unit. As illustrated in FIG. 11, the control unit includes a motherboard 240 a gaming board 250, an actuator, or the like.

The gaming board 250 is provided with a CPU 251, a ROM 255, a boot ROM 252, a card slot 253S corresponding to a memory card 253, and an IC socket 254S corresponding to a GAL 254. The CPU 251, the ROM 255, and the boot ROM 252 are connected to one another through an internal bus.

The memory card 253 stores therein a game program, a game system program, and various types of data for use in the game program and the game system program. Specifically, the memory card 253 stores data such as a program for managing each gaming terminal 10 and a program for running a JP game. Such programs and data are transmitted to the motherboard 240 at the time of boot of the center control unit 200, running of a program, and so forth.

Each of the game program includes a program related to the progress of the JP game. Each of the game programs also includes image data and audio data output during the JP game.

The gaming board 250 has, as illustrated in FIG. 11, a similar structure to the gaming board 50 of the gaming terminal 10, and hence a further explanation of the structure is not given.

The motherboard 240 includes a main CPU 241, a ROM 242, a RAM 243, and a communication interface 244.

The main CPU 41 has at least one of the functions of a terminal controller 100 controlling the entire gaming machine 1, and the main CPU 41 controls a center control unit 200. The ROM 242 stores a program run by the main CPU 241, and permanently-used data. The RAM 243 stores data or a program used for the main CPU 241 to perform a process. The communication interface 244 communicates with the gaming terminals 10 through a communication line.

The ROM 242 also stores a program which extracts random numerical values. The random numerical value extraction program is run by the main CPU 41. In the present embodiment, random numerical value sampling is carried out by a program. The present invention however is not limited to this arrangement. For example, the present invention may be structured to include a random number generating circuit which generates a predetermined range of random numerical values and a sampling circuit which samples a random numerical value from the values generated by the random number generating circuit.

In addition, although not being illustrated, the RON 242 stores data indicating a relation between ranks and random numerical ranges, in the form of a table. This table is referred to when a payout is awarded as a result of a JP game. More specifically, after it is determined that a sampled random numerical value is included in any one of random numerical ranges of the table, a rank corresponding to that range is determined as a rank corresponding to the result of the JP game.

In addition, the RAM 243 stores progressive values accumulatively supplied from each gaming terminal 10. The progressive values are used as the source of payout when jackpot is met in a JP game. The RAM 243 also stores the timing of the next JP game, which is determined when the current JP game finishes.

The center control unit 200 includes, as main actuators, a graphic board 268, a drive motor 270, and a clock IC 280.

The graphic board 268 has the same structure as that of the graphic board 68, except in that the graphic board 268 controls image displaying of the shared display 203 based on a control signal from the main CPU 241.

The drive motor 270 is a stepping motor and is connected to a not-shown drive wheel. The drive motor 270 is driven by a control signal from the main CPU 241, and rotates the drive wheel to move the shared display 203.

The clock IC 280 functions as the timer 228 of the present invention. The clock IC 280 is structured to output data of current time in response to a request from the main CPU 241. For example, the clock IC 28 maybe constituted by an oscillating circuit, a frequency divider, or the like, or may be structured to include software or the like.

The center control unit 200 further includes a power unit 245. The power unit 245 serves as a power source for supplying power to the motherboard 240.

(JP Chance Data Table)

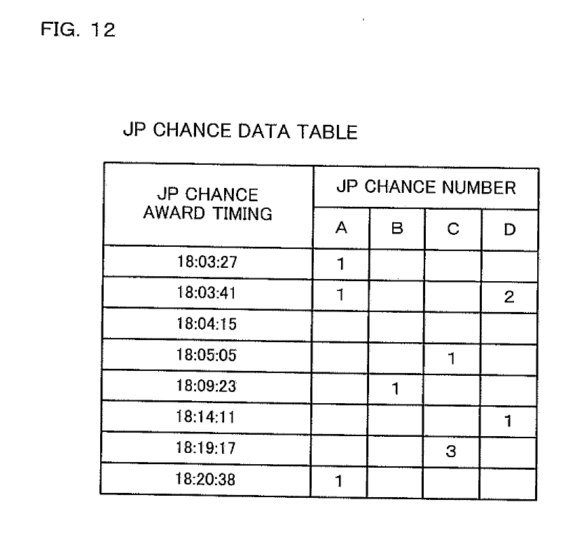

Referring to FIG. 12, a JP chance data table is described. The JP chance data table is stored in the RAM 243 of the center control unit 200. The JP chance data table has a JP chance award timing list and a JP chance number list. The JP chance number list has gaming terminal ID fields (fields A to D). The JP chance award timing list stores time at which a JP chance is awarded to a player in a chance game at each gaming terminal 10. The JP chance number list stores for each gaming terminal ID the number of obtained JP chances. In other words, the JP chance data table is arranged such that the number of JP chances that a gaming terminal 10 has obtained is stored in association with the time at which the JP chance is obtained and the gaming terminal ID of that gaming terminal 10.

Specifically, when a player at the gaming terminal 10 with the gaming terminal ID “A” is awarded a JP chance in a chance game, the gaming terminal 10 transmits a JP chance signal to the center control unit 200. This JP chance signal includes gaming terminal ID information indicating “A” and JP chance number information indicating the number of awarded JP chances. Receiving the JP chance signal, the center control unit 200 increases, in the JP chance data table, the JP chance number associated with the gaming terminal ID along with the time at which the JP chance was obtained.

In a JP game run by the center control unit 200, when the gaming terminals 10 participate in the JP game, the JP chance number corresponding to each of the participating gaming terminals 10 is decremented in the JP chance data table, each time whether jackpot is met or not is determined.

Now, the following will specifically describe the data operation of the JP chance data table by the center control unit 200. When a JP game is run, the JP chance award timing list is searched for a cell storing the earliest time. For the gaming terminal 10 having obtained the number of JP chances corresponding to the time thus found, there is determined whether or not a jackpot is met. The number of JP chances is reduced by 1 each time the determination of whether to meet a jackpot is performed. The determination of whether to meet a jackpot is repeated until the number of JP chances becomes 0. When the aforesaid number of JP chances becomes 0, the JP chance award timing list is searched for the second earliest time, and the data operation above is repeated.

The order in which the gaming terminals 10 participate in the JP game is determined based on the observation that in which gaming terminal ID field of the JP chance number list in the JP chance data table the JP chance number is stored. The order of participation of the gaming terminals 10 in the JP game is temporarily stored in the RAM 243 and is referred to when the pointer images 167 are arranged.

(JP Result Data Table)

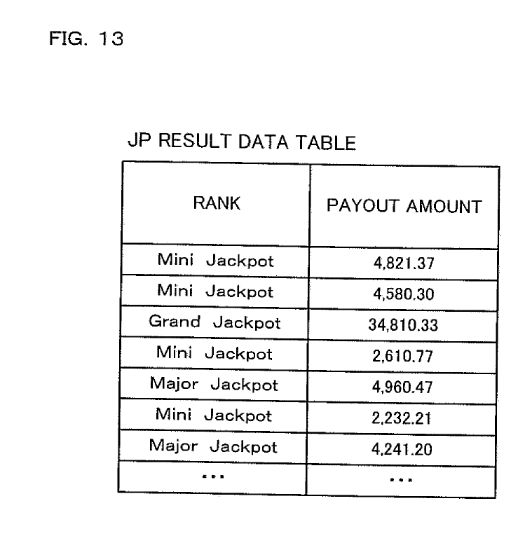

Referring to FIG. 13, a JP result data table is described. The JP result data table is stored in the RAM 243 of the center control unit 200. The JP result data table has a rank list and a payout amount list. The rank list stores a rank achieved as a result of a JP game. The payout amount list stores a payout amount awarded in an achieved rank.

The JP result data table is updated when a result of a JP game is determined. Also, the JP result data table is referred to when, in a JP game, a rank is determined and a payout amount is determined. Specifically, whether or not a JP game result whose rank is identical with a rank determined in a JP game is stored in the table. If such a rank exists, a payout amount is determined to be lower than the payout amount stored in the JP result data table. When the JP game is finished, the data is initialized.

The JP result table is not necessarily structured as above. For example, the table may be updated in such a way that a minimum payout amount of each rank is overwritten. This improves the speed of reference.

(Operation of Gaming Machine 1: Boot Process)

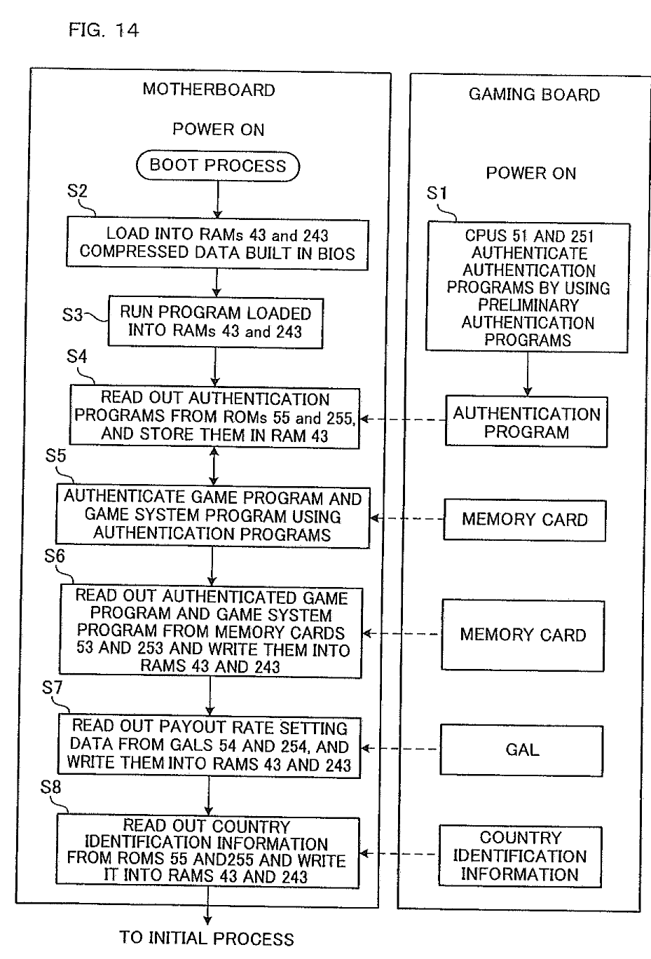

The following describes a boot process routine which takes place in the gaming machine 1. Upon powering on the gaming machine 1, the motherboard 240 and gaming board 250 in the center control unit 200, and the motherboard 40 and the gaming board 50 in the gaming terminal 10 execute the boot process routine illustrated in FIG. 14. The memory cards 53 and 263 are assumed to be inserted into the card slots 53S and 263S of the gaming boards 50 and 250, respectively. Further, the GALs 54 and 254 are assumed to be attached to the IC sockets 54S and 254S, respectively.

First, turning on the power switch of (powering on) the power units 45 and 245 boots the motherboards 40 and 240 and the gaming boards 50 and 250. Booting the motherboards 40 and 240 and the gaming boards 50 and 250 starts separate processes in parallel. Specifically, in the gaming boards 50 and 250,the CPUs 51 and 251 read out preliminary authentication programs stored in the boot ROMs 52 and 252, respectively. Then, preliminary authentication is performed according to the read out programs so as to confirm and authenticate that no modification is made to authentication programs, before reading them in the motherboards 40 and 240, respectively (SI). Meanwhile, the main CPUs 41 and 241 of the motherboards 40 and 240 run BIOS stored in the ROMs 42 and 242 to load into the RAMs 43 and 243 compressed data built in the BIOS, respectively (S2). Then, the main CPUs 41 and 241 run a procedure of the BIOS according to the data loaded into the RAMs 43 and 243 so as to diagnose and initialize various peripheral devices (S3).

The main CPUs 41 and 241, which are respectively connected to the ROMs 55 and 255 of the gaming boards 50 and 250 via PCI buses, read out authentication programs stored in the ROMs 55 and 255 and store them in the RAMs 43 and 243 (S4). During this step, the main CPUs 41 and 241 each derives a checksum through ADDSUM method (a standard check function) which is adopted in a standard BIOS, and store the authentication programs into RAMs 43 and 243 while confirming if the operation of storing is carried out without an error.

Next, the main CPUs 41 and 241 each checks what connects to the IDE bus. Then, the main CPUs 41 and 241 access, via the IDE buses, to the memory cards 53 and 253 inserted into the card slots 53S and 253S, and read out game programs and game system programs from the memory cards 53 and 253, respectively. In this case, the CPUs 41 and 241 each reads out four bytes of data constituting the game program and the game system program at one time. Next, the CPUs 41 and 241 authenticate the game program and the game system program read out to confirm and prove that these programs are not modified, in accordance with the authentication programs stored in the RAMs 43 and 243 (S5).

When the authentication properly ends, the main CPUs 41 and 241 write and store the authenticated game programs and game system programs in RAMs 43 and 243 (S6).

Next, the main CPUs 41 and 241 access, via the PCI buses, to the GALs 54 and 254 attached to the IC sockets 54S and 2548, and read out payout rate setting data from the GALs 54 and 254, respectively. The payout rate setting data read out is then written and stored in the RAMs 43 and 243 (S7).

Next, the main CPUs 41 and 241 read out, via the PCI buses, country identification information stored in the ROMs 55 and 255 of the gaming boards 50 and 255, respectively. The country identification information read out is then stored in the RAMs 43 and 243 (S8).

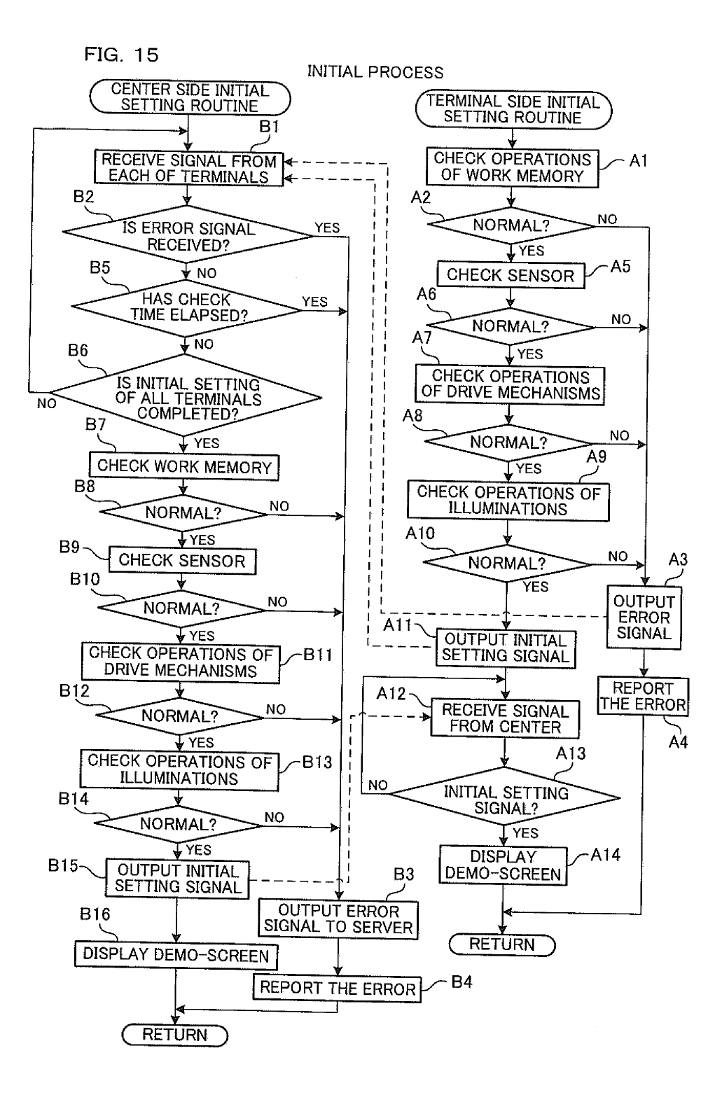

After this, the main CPUs 41 and 241 each performs an initial process of FIG. 15.

(Operation of Gaming Machine 1: Initial Process)

The following describes an initial process which takes place in the gaming machine 1. After the execution of the boot process shown in FIG. 14, the center control unit 200 reads out from the RAM 243 and executes a center side initial setting routine shown in FIG. 15. Meanwhile, after the execution of the boot process shown in FIG. 14, the gaming terminal 10 reads out from the RAM 43 a terminal side initial setting routine illustrated in FIG. 15 and executes the routine. The center side and terminal side initial setting routines are executed in parallel.

First, the main CPU 41 of the gaming terminal 10 checks operations of a work memory such as RAM 43 (A1). Then, the main CPU 41 determines if all the check results are normal (A2). If the main CPU 41 determines that the check results contain an error (A2: NO), an error signal is supplied to the center control unit 200 (A3). Further, the error is notified in the form of illuminating the lamp 30 or the like (A4), and then the routine is ended.

On the other hand, if the main CPU 41 determines that the check results are all normal (A2:YES), the main CPU 41 checks operations of various sensors (A5). Then, the main CPU 41 determines if all the check results are normal (A6). If the main CPU 41 determines the check results contain an error (A6: NO), the main CPU 41 executes A3.

On the other hand in A6, if the main CPU 41 determines that the check results are all normal (A6: YES), the main CPU 41 checks operations of various drive mechanisms (A7). Then, the main CPU 41 determines if all the check results are normal (A8). If the main CPU 41 determines the check results contain an error (A8: NO), the main CPU 241 executes A3.

On the other hand in A8, if the main CPU 41 determines that the check results are all normal (A8: YES), the main CPU 41 checks operations of various illuminations (A9). Then, the main CPU 41 determines if all the check results are normal (A10). If the main CPU 41 determines the check results contain an error (A10: NO), the main CPU 41 executes A3.

After the checking operations through the steps A1 to A10 for checking operations of various functions, if the main CPU 41 determines that the check results are all normal (A10: YES), the main CPU 41 outputs an initial setting signal to the center control unit 200 (A11). Thereafter the process waits for the supply of an initial setting signal from the center control unit 200 (A12, A13: NO).

Then the main CPU 241 of the center control unit 200 receives a signal from each gaming terminal 10 (B1). Then, the main CPU 241 determines whether a signal received is an error signal (B2). If the main CPU 241 determines that the signal is an error signal (B2: YES), the main CPU 241 outputs the error signal to a server of a not-illustrated host computer or the like (B3) to report the error (B4), and ends the routine.

On the other hand in B2, if the main CPU 241 determines that the signal is not an error signal (B2:NO), the main CPU 241 determines whether a predetermined time (check time) has elapsed from the time of powering on (B5). If the main CPU 241 determines that the check time has elapsed (B5: YES), B3 is executed. On the other hand, if the main CPU 241 determines that the check time has not yet elapsed (B5:NO), it is determined whether an initial setting signal is received from each of the gaming terminals 10 (B6). If the main CPU 241 determines that an initial setting signal from any one of the gaming terminals 10 is not received (B6: NO), the process returns to B1.

On the other hand, if the main CPU 241 determines that initial setting signals from all the gaming terminals 10 are received (B6: YES), the main CPU 241 checks operations of work memory such as the RAM 243 (B7). Then, the main CPU 241 determines whether all the check results are normal (B8). If the main CPU 241 determines the check results contain an error (B8: NO), the main CPU 241 executes B3.

On the other hand, if the main CPU 241 determines that the check results are all normal (B8:YES), the main CPU 241 checks operations of various sensors (B9). Then, the main CPU 241 determines whether all the check results are normal (B10). If the main CPU 241 determines the check results contain an error (B10: NO), the main CPU 241 executes B3.

On the other hand in B10, if the main CPU 241 determines that the check results are all normal (B10:YES), the main CPU 241 checks operations of various driving mechanisms (B11). Then, the main CPU 241 determines whether all the check results are normal (P12). If the main CPU 241 determines the check results contain an error (B12: NO), the main CPU 241 executes B3.

On the other hand in B12, if the main CPU 241 determines that the check results are all normal (B12: YES), the main CPU 241 checks operations of various illuminations (B13). Then, the main CPU 241 determines whether all the check results are normal (B14). If the main CPU 241 determines the check results contain an error (R14: NO), the main CPU 241 executes B3.

After the checking operations through the steps B7 to B14, if the main CPU 241 determines in B14 that all the check results are normal (B14: YES), the main CPU 241 outputs an initial setting signal to all the gaming terminals 10 (B15), and causes the shared display 203 to display a demo-screen (B16). Then, the main CPU 241 ends the routine.

In A12, the main CPU 41 of each of the gaming terminals 10 determines that an initial setting signal is received from the center control unit 200 (A13: YES), and causes the terminal display 101 to display a demo-screen (A14). The main CPU 41 then ends the routine.

(Operation of Gaming Terminal 10: Game Running Process Routine)

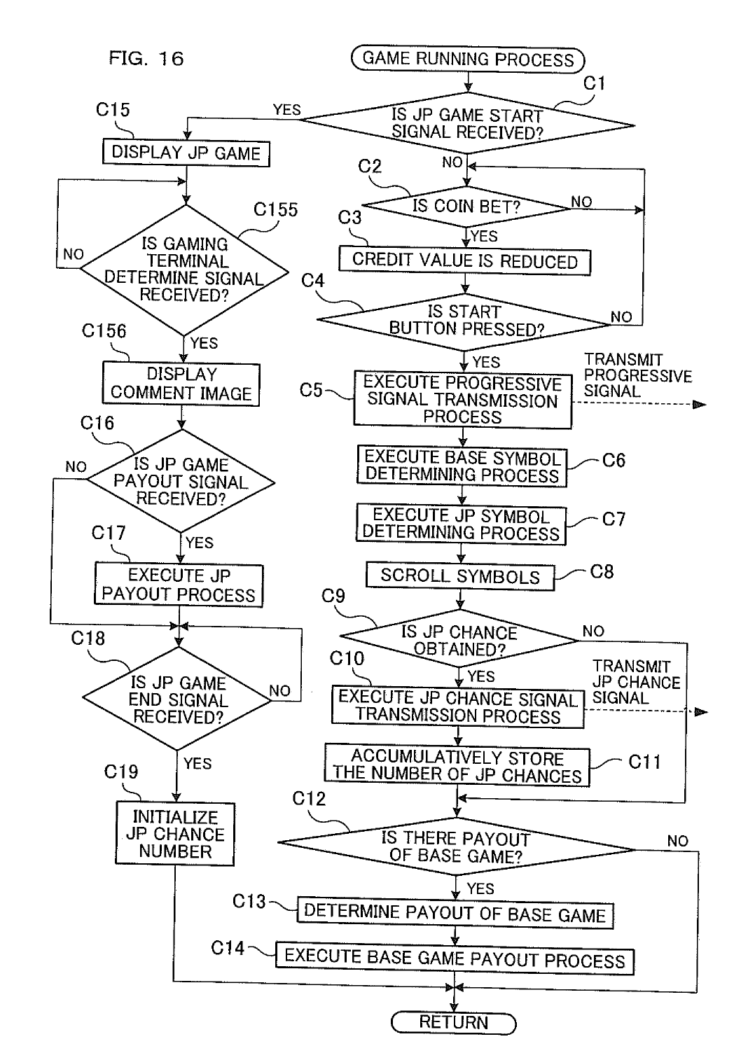

After the terminal side initial setting routine of FIG. 15, the main CPU 41 of the gaming terminal 10 performs a game running process routine of FIG. 16. Through this game running process routine, a game is run.

As illustrated in FIG. 16, in the game running process routine, whether or not a JP game start signal is received from the center control unit 200 is determined (C1). In C1, if it is determined that no JP game start signal is received (C1:NO), whether a coin is bet or not is determined (C2). In this step, it is determined whether a signal from the 1-BET button switch 26S entered by pressing of the 1-BET button 26 is received. Meanwhile, it is determined whether a signal from the maximum BET switch 27S entered by pressing of the maximum BET button 27 is received. If no coin is BET (C2: NO), C2 is repeated until a coin is bet.

On the other hand, if a coin is bet (C2: YES), the credit-value stored in the RAM 43 is reduced according to the number of coins bet (C3). When the number of coins bet surpasses the credit value stored in the RAM 43, the process goes to a later-detailed step C4 without the reduction of the credit-value. When the number of coins bet exceeds the maximum number of coins bettable in one game (50 pieces in this embodiment), the process goes to a later-detailed step C4 without the reduction of the credit-value.

Then, it is determined whether a spin button 23 is pressed or not (C4). If the spin button 23 is not pressed (C4: NO), the process returns to C2. Here, if the spin button 23is not pressed (for example, the spin button 23 is not pressed but a command to end the game is input), the reduction of the credit value in C3 is canceled.

On the other hand, when the spin button 23 is pressed (C4: YES), a progressive transmission process is executed (C5). In other words, a progressive signal indicating a part of the betted progressive value is transmitted to the center control unit 200.

Next executed is a base symbol determining process (C6). That is, the stop symbol determining program stored in the RAM 43 is run to determine base symbols 180 to be stopped in the matrix 156. This determines a combination of base symbols to be stopped in the matrix 156.

Next executed is a JP symbol determining process (C7). That is, the stop symbol determining program stored in the RAM 43 is run to determine JP symbols 180J to be stopped in the matrix 156. Through this step is determined a combination of JP symbols to be stopped in the matrix 156.

Then, the scrolling process is executed to scroll base symbols 180 and JP symbols 180J at the same time, on the terminal display 101 (C8). The scrolling process is a process in which the base symbols 180 and the JP symbols 180J respectively determined in C6 and C7 are stopped (rearranged) in the matrix 156 after scrolling of symbols 180 and JP symbols 180J in an upward/downward direction.

Then whether to award a JP chance is determined by determining whether a predetermined number or more of JP symbols 180J are rearranged on the matrix 156 (C9). If it is determined that no JP chance is awarded (C9:NO), there is determined whether a payout is awarded as a result of the base game by determining whether a winning combination is achieved by the base symbols 180 rearranged on the matrix 156 (C12).

In the meanwhile, if it is determined in C9 that a JP chance is awarded (C9:YES), a JP chance signal including the number of JP chances and the gaming terminal ID of the gaming terminal 10 is transmitted to the center control unit 200 (C10). After C10, the number of JP chances is accumulatively stored in the RAM 43 (C11). In this step, the accumulated total number of the JP chances is displayed in the JP chance display area 160 of the lower image display panel 16.

Subsequently, if it has been determined in C12 that there is payout as a result of the base game (C12:YES), an amount of payout is determined based on the rearranged base symbols 180 (C13). After the payout is determined, a pay out process is executed (C14). On the other hand in C12, if it is determined that there is no payout as a result of the base game (C12: NO), this routine is ended.

On the other hand, if in C1 a JP game start signal has been received from the center control unit 200 (C1:YES), an effect image regarding the JP game is displayed on the lower image display panel 16 (C15). Specifically, the character image 162 shown in the lower part of FIG. 4 is displayed.

Then it is determined whether a gaming terminal determine signal is received from the center control unit 200 (C155). The gaming terminal determine signal notifies a gaming terminal 10 of its turn to receive the determination of whether a jackpot is met in a JP game. If no gaming terminal determine signal has been received (C155: NO), the process of the step C155 is repeated. When the gaming terminal determine signal has been received (C155:YES), a comment image 163 is displayed (C156). Specifically, the comment image 163 shown on the gaming terminal 10b in the lower part of FIG. 4 is displayed in the vicinity of the character image 162.

When a JP game is started in this way, a player is on standby while a character image 162 is displayed, and he/she recognizes that his/her turn in a JP game has come when a comment image 163 is displayed in the vicinity of the character image 162.

After an effect image regarding the JP game is displayed on the lower image display panel 16 in C156, there is determined whether a JP game payout signal is received from the center control unit 200 (C16). If it is determined that no JP game payout signal is received (C16:NO), there is determined whether a JP game end signal is received from the center control unit 200 (C18).

On the other hand, if it is determined that a JP game payout signal is received from the center control unit 200 in C16 (C16:YES), a JP payout process is executed based on the JP game payout signal (C17). Specifically, the JP payout process is carried out in such a way that, as shown in the lower part of FIG. 5, a character image 162 and a payout image 164 are displayed and a payout is awarded. C18 is executed thereafter.

If it is determined that no JP game end signal is received (C18:NO), a JP game end signal is waited (C18).

On the other hand, if it is determined in C18 that a JP game end signal is received from the center control unit 200 (C18:YES), the number of JP chances stored in the RAM 43 is set at an initial value (C19). In this step, the number of JP chances displayed on the JP chance display area 160 of the lower image display panel 16 is also set at the initial value. This routine ends thereafter.

(Operation of Center Control Unit 200: Progressive Add Process Routine)

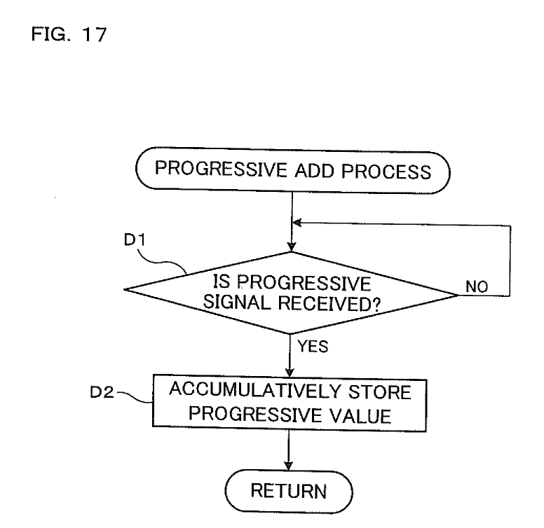

FIG. 17 shows a progressive add process routine in the center control unit 200. When the progressive add process routine is executed, the main CPU 241 of the center control unit 200 determines whether a progressive signal is received from a gaming terminal 10 (D1). If the center control unit 200 determines that no progressive signal is received (D1:NO), the center control unit 200 waits for a progressive signal (D1).

On the other hand, if the center control unit 200 determines in D1 that a progressive signal is received from a gaming terminal 10 (D1:YES), the center control unit 200 accumulatively stores a progressive value indicated by the progressive signal in the RAM 243 (D2). This routine ends thereafter.

(Operation of Center Control Unit 200: JP Chance Add Process routine)

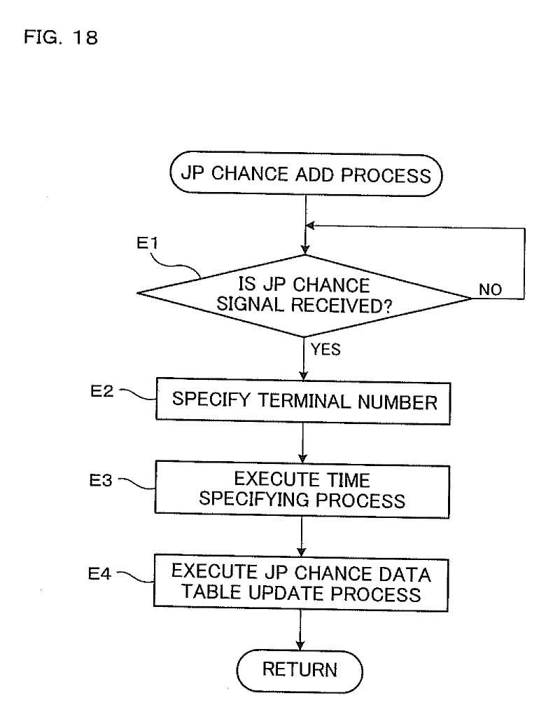

FIG. 18 shows a JP chance add process routine in the center control unit 200. When the JP chance add process routine is executed, the main CPU 241 of the center control unit 200 determines whether a JP chance signal is received from a gaming terminal 10 (E1). If the center control unit 200 determines that no JP chance signal is received (E1: NO), the center control unit 200 waits for the JP chance signal (E1).

On the other hand, if it is determined in E1 that a JP chance signal has been received from a gaming terminal 10 (E1:YES), the gaming terminal ID of the gaming terminal 10 which has transmitted the signal is specified with reference to the JP chance signal (E2) Then a time measuring process is carried out. Specifically, the clock IC 280 outputs current time to the main CPU 241, in response to a request from the main CPU 241. Then, the “gaming terminal ID” specified in E2, the “current time” specified in E3, and the “number of JP chances” which is based on the JP chance signal are associated with one another, and the associated sets of data are stored and updated in the JP chance data table of the RAM 243 (E4). This routine ends thereafter.

(Operation of Center Control Unit 200: JP Game Running Process Routine)

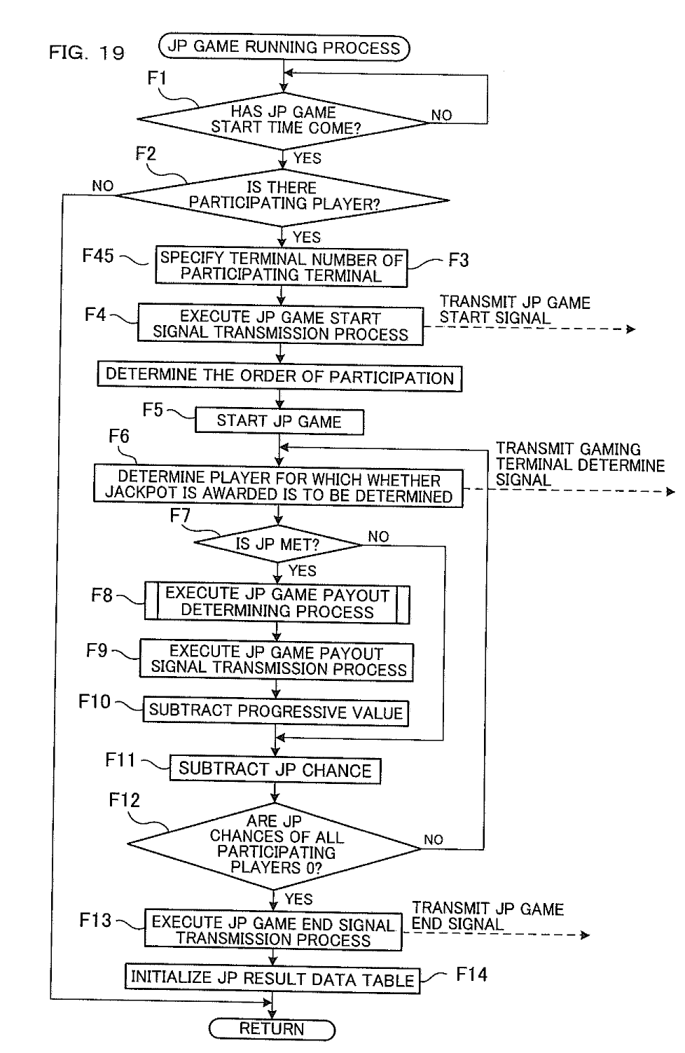

FIG. 19 shows a JP game running process routine executed by the main CPU 241 of the center control unit 200. When the JP game running process routine is executed, the center control unit 200 determines whether a JP game starting time has come (F1). If the center control unit 200 determines the JP game starting time has not come (F1:NO) the JP game starting time is waited (F1).

On the other hand in F1, if the center control unit 200 determines the JP game starting time has come (F1:YES), the center control unit 200 determines if there is a gaming terminal 10 to participate in the JP game, by referring to the JP chance data table stored in RAM 243 (F2). If it is determined that no gaming terminal 10 participates (F2:NO), the routine is ended.

On the other hand in F2, if there is a gaming terminal 10 to participate in the JP game (F2:YES), the center control unit 200 specifies the gaming terminal ID of that gaming terminal 10 (F3). Specifically, the JP chance data table of the RAM 243 is searched for so that whether the number of JP chances is stored in each gaming terminal ID field of the JP chance number list is checked, with the result that a gaming terminal ID for which the number of JP chances has been stored is specified. Thereafter, a JP game start signal is transmitted to the gaming terminal 10 corresponding to the gaming terminal ID specified in F4 (F4). Then the order in which the gaming terminals 10 participate in the JP game is determined based on the JP chance data table in the RAM 243 (F45). The order of participation of the gaming terminals 10 in the JP game is determined to correspond to the temporal order of obtaining JP chances. This order of participation is stored in the RAM 243. Thereafter the JP game is started (F5). Specifically, as illustrated in the upper part of FIG. 6, the pointer images 167 are arranged on the shared display in accordance with the order of participation determined in F45, and then the pointer images 167 are scrolled on the shared display.

As a result of this the pointer image 167 corresponding to the gaming terminal 10 at which the player is playing the game is displayed on the shared display 203, and hence the player can recognize that he/she is participating in the JP game and can enjoy a new entertainment characteristic of sharing a sense of participation with other players.

When the JP game starts in F5, selected is a gaming terminal 10 to be subjected to a process of determining whether or not a jackpot is awarded. (F6). Specifically, as discussed above, the order of gaming terminals 10 to be selected is determined with reference to the temporal order of awarding JP chances in the JP chance data table shown in FIG. 12. After the selection a gaming terminal determine signal is transmitted to the gaming terminal 10 thus selected. At the same time, the graphic board 268 is controlled so that the pointer image 167 indicating the thus determined gaming terminal 10 reaches the line image 165 on the shared display 203.

Then, a process of determining whether or not a jackpot is awarded is performed with respect to a gaming terminal 10 with the gaming terminal ID determined in F7 (F7). If it is determined that a jackpot is not made (F7:NO), the number of JP chances obtained by the gaming terminal 10 with the determined gaming terminal ID, which number is stored in the RAM 243, is reduced by “1” (F11).

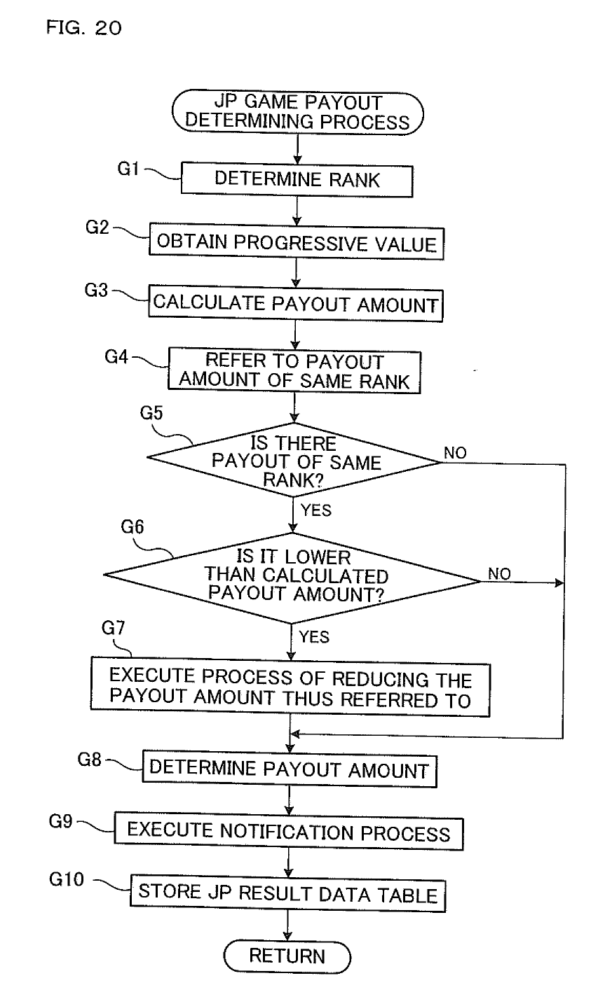

On the other hand, if in F7 it is determined that a jackpot is met (F7:YES), a JP game payout determining process is executed (F8) so that an amount of the payout is determined. This JP game payout determining process will be described later with reference to FIG. 20. After the process of F8, a JP game payout signal is transmitted to the gaming terminal 10 having the thus determined gaming terminal ID (F9). It is noted that the JP game payout signal includes the determined number of payout of the JP game.

Next, a progressive value corresponding to the number of payout of the JP game determined in FE is subtracted from the accumulated progressive value in the RAM 243 (F10). After F10 is played F11.

After F11, there is determined whether JP chances of all the gaming terminals 10 stored in the RAM 243 are consumed (F12). If it is determined that there is a JP chance yet to be consumed (F12: NO), a gaming terminal 10, for which whether jackpot is awarded is to be determined, is determined again (F6).

On the other hand, if it is determined in F12 that all JP chances are consumed (F12:YES), a JP game end signal is transmitted to the gaming terminal 10 to which the JP game start signal have been transmitted (F13). Thereafter the JP result data table is initialized (F14), and the routine is finished.

Now, referring to FIG. 20, the following describes a JP game payout determining process routine executed by the main CPU 241 of the center control unit 200. First, the main CPU 241 determines a rank (G1). Then a progressive value to be stored in the RAM 243 is obtained (G2). Based on the obtained progressive value, a payout amount whose ratio corresponds to the rank is figured out (G3).

Thereafter the JP result data table is checked whether a payout amount whose rank is identical with the rank determined in the step G1 has been stored (G4). Whether a payout in the same rank is stored is determined as a result of the checking (G5). If a payout in the same rank has been stored in the JP result data table (G5:YES), the calculated payout amount is compared with the stored payout amount and there is determined whether the stored payout amount is lower than the calculated payout amount (G6). If it is determined that the stored payout amount is lower than the calculated payout amount (G6:NO), a process of reducing the payout amount thus referred to is executed (G7). Specifically, the payout amount thus referred to is multiplied by 0.95 (G8).

A payout amount determining process is executed if the process of the step G8 has been finished, if there is no payout in the same rank in the step G5, or the payout amount thus referred to is higher than the payout amount calculated in the step G6 (G8). Specifically, when the process of the step G7 has been executed, the reduced payout amount is determined as a payout amount of the JP game. In other cases, the payout amount calculated from the progressive value is determined as a payout amount of the JP game.

Then a notification process is executed (G9). Specifically, as illustrated in FIG. 5, a rank image 168 is displayed in accordance with the rank, a payout amount image 169 is displayed in accordance with the payout amount, and a character image 162 is displayed in accordance with the gaming terminal ID.

Further displayed is a payout image 164 corresponding to the rank. That is to say, displayed is a payout image 164 having the size corresponding to the number of cases in the same rank stored in the rank list of the JP result table. Specifically, the more the number of cases in the same rank as the rank corresponding to the payout image 164 is, the smaller the size of the displayed payout image 164 is.

In this way, in the gaming machine 1 of the present embodiment, concurrently run are a base game offering a chance of winning a payout according to a predetermined combination and a chance game offering a chance of obtaining a JP chance which qualifies a player to join a JP game offering a chance of winning a higher payout than the base game. A payout is determined according to a result of the base game and awarded. In accordance with a result of the chance game, there is determined whether a JP chance is awarded. When a JP chance is awarded, the number of awarded JP chances is stored in the RAM 243 in association with the time of awarding the JP chance specified by the clock IC 280. A timing to run a JP game is determined in accordance with the timing to award the JP chance. A pointer image 167 based on the timing to run the JP game is displayed on the shared display 203. At the timing to run the JP gamer the JP game is run in which a player participates by consuming a JP chance stored in the RAM 243. A rank is determined according to a result of the JP game and awarded. Based on the determined rank and the timing to run the JP game, a payout of the JP game is determined. The determined payout of the JP game is awarded.

As a result of this, a payout of a JP game is determined by a rank determined according to a result of the JP game and a timing to run the JP game. This provides players with a new entertainment characteristic.

Furthermore, since a timing to run a JP game is displayed on the shared display 203, a player is motivated to continue a game thanks to decreased stress on him/her.

In the gaming machine 1 of the present embodiment, concurrently run in each gaming terminal 10 which is capable of independently run a game are a base game which is configured to award a payout according to a predetermined combination and a chance game offering a chance of obtaining a JP chance which qualifies a player to join a JP game offering a chance of winning a higher payout than the base game. A payout is determined according to a result of the base game and awarded. In accordance with a result of the chance game, there is determined whether a JP chance is awarded. When a JP chance is awarded, the number of awarded JP chances is stored in the RAM 243 for each gaming terminal 10, in association with the time of awarding the JP chance specified by the clock IC 280. A timing to run a JP game is determined in accordance with the timing to award the JP chance. A pointer image 167 based on the timing to run the JP game is displayed on the shared display 203. At the timing to run the JP game, the JP game is run in which a player participates by consuming a JP chance stored in the RAM 243. A rank is determined according to a result of the JP game. If the RAM 243 stores a result in the same rank as the determined rank, a lower payout than the payout stored in the RAM 243 is determined as a payout of the JP game. The determined payout of the JP game is stored in the RAM 243 in association with the determined rank, and the determined payout of the JP game is awarded.

As a result of the above, a payout of a JP game is determined by a rank determined according to a result of the JP game and a timing to run the JP game. Specifically, a player for whom a JP game is run earlier than for another player receives a higher payout, even if the rank of these players is the same. This provides players with a new entertainment characteristic.

Furthermore, since a timing to run a JP game is displayed on the shared display 203, a player is motivated to continue a game thanks to decreased stress on him/her.

In the gaming machine 1 of the present embodiment, concurrently run are a base game which is executed in response to the consumption of a predetermined game value and is configured to award a payout according to a predetermined combination and a chance game offering a chance of obtaining a JP chance which qualifies a player to join a JP game offering a chance of winning a higher payout than the base game. A part of the consumed game value is stored in the RAM 243. A payout is determined according to a result of the base game and awarded. In accordance with a result of the chance game, there is determined whether a JP chance is awarded. When a JP chance is awarded, the number of awarded JP chances is stored in the RAM 243 in association with the time of awarding the JP chance specified by the clock IC 280. A timing to run a JP game is determined in accordance with the timing to award the JP chance. A pointer image 167 based on the timing to run the JP game is displayed on the shared display 203. At the timing to run the JP game, the JP game is run in which a player participates by consuming a JP chance stored in the RAM 243. A rank is determined according to a result of the JP game. A payout of the JP game is determined according to the determined rank, the timing to run the JP game, and the game value accumulatively stored in the RAM 243. The determined payout of the JP game is awarded.

As a result of this, a payout of a JP game is determined by a rank determined according to a result of the JP game, a timing to run the JP game, and a game value accumulatively stored in the RAM 243. This provides players with a new entertainment characteristic.

Furthermore, since a timing to run a JP game is displayed on the shared display 203, a player is motivated to continue a game thanks to decreased stress on him/her.

In the gaming machine 1 of the present embodiment, concurrently run in gaming terminals 10 each capable of independently run a game are a base game which is executed in response to the consumption of a predetermined game value and is configured to award a payout according to a predetermined combination and a chance game offering a chance of obtaining a JP chance which qualifies a player to join a JP game offering a chance of winning a higher payout than the base game. A part of the consumed game value is stored in the RAM 243. A payout is determined according to a result of the base game and awarded. In accordance with a result of the chance game, there is determined whether a JP chance is awarded. When a JP chance is awarded, the number of awarded JP chances is stored in the RAM 243 for each gaming terminal 10, in association with the time of awarding the JP chance specified by the clock IC 280. A timing to run a JP game is determined in accordance with the timing to award the JP chance. A pointer image 167 based on the timing to run the JP game is displayed on the shared display 203. At the timing to run the JP game, the JP game is run in which a player participates by consuming a JP chance stored in the RAM 243. A rank is determined according to a result of the JP game. If the RAM 243 stores a result in the same rank as the determined rank, a lower payout than the payout stored in the RAM 243 is determined as a payout of the JP game, based on the game value accumulatively stored in the RAM 243. The determined payout of the JP game is stored in the RAM 243 in association with the determined rank, and the determined payout of the JP game is awarded.

As a result of this, a payout of a JP game is determined by a rank determined according to a result of the JP game, a timing to run the JP game, and a game value accumulatively stored in the RAM 243. This provides players with a new entertainment characteristic. Specifically, a player for whom a JP game is run earlier than for another player receives a higher payout, even if the rank of these players is the same. This provides players with a new entertainment characteristic.

Furthermore, since a timing to run a JP game is displayed on the shared display 203, a player is motivated to continue a game thanks to decreased stress on him/her.

Note that this embodiment deals with a case where the JP game is run for a gaming terminal 10 having one or more JP chance; however, the present invention is not limited to this. For example, the JP game may be run for a gaming terminal 10 having three or more JP chances.

In the present embodiment, a payout of a JP game for a player is determined based on an accumulatively-stored progressive value. The present invention however is not limited to this arrangement. For example, among players whose payout in response to a JP game is in the same rank, those who are not the first participant of a JP game may receive an initial value of the progressive value. In this case, for example, provided that the accumulative storing of the progressive value starts from 1000 dollars, among players in the same rank a player who has participated in a JP game first receives a payout according to the accumulatively-stored progressive value, whereas all of the players who participate in the JP game second or later receives 1000 dollars. As a result, players are motivated to obtain a JP chance (chance flag) as soon as possible. This further enhances the entertainment characteristic.

The detailed description of the present invention provided hereinabove mainly focused on characteristics thereof for the purpose of easier understanding; however, the scope of the present invention shall be construed as broadly as possible, encompassing various forms of other possible embodiments, and therefore the present invention shall not be limited to the above description. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The above descriptions include processes executed on a computer or a computer network. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes performed in the steps or blocks, these processes are essentially executed by various devices. Further, the other structures necessary for the steps or blocks are obvious from the above descriptions.

What is claimed is:

1. A gaming machine comprising:
a base game offering a chance of winning a payout according to a predetermined combination;
a special game offering a chance of winning a higher payout than the base game;
a chance game offering a chance of obtaining a chance flag which qualifies a player to join the bonus game;
a timer which specifies a timing at which the chance flag is awarded; and
a chance flag memory which stores the number of awarded chance flags,
a display which displays an image based on the chance flag and the timing; and
a controller which is programmed to perform the steps of:
(a1) running the base game and the chance game at the same time;
(a2) determining and awarding a payout according to a result of the base game;
(a3) determining whether to award a chance flag according to a result of the chance game;
(a4) if the chance flag is awarded, storing the number of awarded chance flags in the chance flag memory, in association with a timing at which the chance flag is awarded, which is specified by the timer;
(a5) determining a timing to run the special game based on the timing at which the chance flag is awarded;
(a6) displaying on the display an image based on the timing to run the special game;
(a7) at the timing to run the special game, running the special game in which the player participates by consuming the chance flag stored in the chance flag memory;
(a8) determining a rank according to a result of the special game;
(a9) determining a payout of the special game according to the determined rank and the timing to run the special game; and
(a10) awarding the determined payout of the special game.

2. A gaming machine, comprising:
gaming terminals each capable of independently running a game;
a base game offering a chance of winning a payout according to a predetermined combination;
a special game offering a chance of winning a higher payout than the base game, in which game the gaming terminals participate in turn;
a chance game offering a chance of obtaining a chance flag which qualifies a player to join the bonus game;
a timer which specifies a timing at which the chance flag is awarded; and
a chance flag memory which stores the number of awarded chance flags, a display which displays an image based on the chance flag and the timing;
a result memory which stores a rank according to a result of the special game and a payout in association with one another; and
a controller which is programmed to perform the steps of:
(b1) running the base game and the chance game at the same time in each of the gaming terminals;
(b2) determining and awarding a payout according to a result of the base game;
(b3) determining whether to award a chance flag according to a result of the chance game;
(b4) if the chance flag is awarded, storing the number of awarded chance flags in the chance flag memory for each of the gaming terminals, in association with a timing at which the chance flag is awarded, which is specified by the timer;
(b5) determining a timing to run the special game based on the timing at which the chance flag is awarded;
(b6) displaying on the display an image based on the timing to run the special game;
(b7) at the timing to run the special game, running the special game in which the player participates by consuming the chance flag stored in the chance flag memory;
(b8) determining a rank according to a result of the special game;
(b9) if the result memory stores a result whose rank is identical with the determined rank, determining a payout of the special game to be lower than a payout of the result stored in the result memory; and
(b10) storing the determined payout of the special game in the result memory in association with the determined rank and awarding the determined payout of the special game.

3. A gaming machine comprising:
a base game which is run in response to consumption of a predetermined game value and offers a chance of winning a payout according to a predetermined combination;
a payout memory which accumulatively stores, as a payout for a special game, a part of the consumed game value;
a special game offering a chance of winning a higher payout than the base game;
a chance game offering a chance of obtaining a chance flag which qualifies a player to join the bonus game;
a timer which specifies a timing at which the chance flag is awarded; and
a chance flag memory which stores the number of awarded chance flags,
a display which displays an image based on the chance flag and the timing; and
a controller which is programmed to perform the steps of:
(c1) running the base game and the chance game at the same time;
(c2) storing in the payout memory a part of the consumed game value;
(c3) determining and awarding a payout according to a result of the base game;
(c4) determining whether to award a chance flag according to a result of the chance game;
(c5) if the chance flag is awarded, storing the number of awarded chance flags in the chance flag memory, in association with a timing at which the chance flag is awarded, which is specified by the timer;
(c6) determining a timing to run the special game based on the timing at which the chance flag is awarded;
(c7) displaying on the display an image based on the timing to run the special game;
(c8) at the timing to run the special game, running the special game in which the player participates by consuming the chance flag stored in the chance flag memory;
(c9) determining a rank according to a result of the special game;
(c10) determining a payout of the special game according to the determined rank, the timing to run the special game, and the game value accumulatively stored in the payout memory; and
(c11) awarding the determined payout of the special game.

4. A gaming machine comprising:
gaming terminals each capable of independently running a game;
a base game which is run in response to consumption of a predetermined game value and offers a chance of winning a payout according to a predetermined combination;
a payout memory which accumulatively stores, as a payout for a special game, a part of the consumed game value;
a special game offering a chance of winning a higher payout than the base game, in which game the gaming terminals participate in turn;
a chance game offering a chance of obtaining a chance flag which qualifies a player to join the bonus game;
a timer which specifies a timing at which the chance flag is awarded; and
a chance flag memory which stores the number of awarded chance flags,
a display which displays an image based on the chance flag and the timing;
a result memory which stores a rank according to a result of the special game and a payout in association with one another; and
a controller which is programmed to perform the steps of:
(d1) running the base game and the chance game at the same time in each of the gaming terminals;
(d2) storing in the payout memory a part of the consumed game value;
(d3) determining and awarding a payout according to a result of the base game;
(d4) determining whether to award a chance flag according to a result of the chance game;
(d5) if the chance flag is awarded, storing the number of awarded chance flags in the chance flag memory for each of the gaming terminals, in association with a timing at which the chance flag is awarded, which is specified by the timer;
(d6) determining a timing to run the special game based on the timing at which the chance flag is awarded;
(d7) displaying on the display an image based on the timing to run the special game;
(d8) at the timing to run the special game, running the special game in which the player participates by consuming the chance flag stored in the chance flag memory;
(d9) determining a rank according to a result of the special game;
(d10) if the result memory stores a result whose rank is identical with the determined rank, determining a payout of the special game to be lower than a payout of the result stored in the result memory, according to the game value accumulatively stored in the payout memory; and
(d11) storing the determined payout of the special game in the result memory in association with the determined rank and awarding the determined payout of the special game.

5. A method of playing a gaming machine which comprises:
a base game offering a chance of winning a payout according to
a predetermined combination;
a special game offering a chance of winning a higher payout than the base game;
a chance game offering a chance of obtaining a chance flag which qualifies a player to join the bonus game;
a timer which specifies a timing at which the chance flag is awarded; and
a chance flag memory which stores the number of awarded chance flags; and
a display which displays an image based on the chance flag and the timing,
the method comprising the steps of:
(e1) running the base game and the chance game at the same time;
(e2) determining and awarding a payout according to a result of the base game;
(e3) determining whether to award a chance flag according to a result of the chance game;
(e4) if the chance flag is awarded, storing the number of awarded chance flags in the chance flag memory, in association with a timing at which the chance flag is awarded, which is specified by the timer;
(e5) based on the timing at which the chance flag is awarded, determining a timing to run the special game;
(e6) displaying on the display an image based on the timing to run the special game;
(e7) at the timing to run the special game, running the special game in which a player participates by consuming the chance flag stored in the chance flag memory;
(e8) determining a rank according to a result of the special game;
(e9) determining a payout of the special game according to the determined rank and the timing to run the special game; and
(e10) awarding the determined payout of the special game.
